(19) United States
(12) Patent Application Publication
(10) Pub. No.: US 2026/0050169 A1
(43) Pub. Date: Feb. 19, 2026

(54) NEAR-EYE DISPLAY MODULE AND NEAR-EYE DISPLAY DEVICE

(71) Applicant: GYGES LABS PTE. LTD., Kaki Bukit (SG)

(72) Inventors: Yanzhi CHEN, SHENZHEN (CN); Yingnan ZHAI, SHENZHEN (CN); Zheng LYU, SHENZHEN (CN); Can YE, SHENZHEN (CN)

(73) Assignee: GYGES LABS PTE. LTD., Kaki Bukit (SG)

(21) Appl. No.: 18/806,768

(22) Filed: Aug. 16, 2024

(51) Int. Cl. G02B 27/01

(52) U.S. Cl. CPC G02B 27/0176; G02B 2027/0178

(57) ABSTRACT

A near-eye display module and a near-eye display device are provided. A housing defines an installation space, and the control plate assembly is located in the installation space. The control plate assembly includes a main control plate and an adapter plate. A display assembly includes a first base, a second base, and a micro-display. The storage assembly is electrically connected to the display assembly. The storage assembly includes a second plate body, a first plate body, and a storage chip. The first plate body is configured to be non-parallel to the second plate body after folding a fifth fold section. The adapter plate is configured to at least partially overlap with the main control plate after folding a first fold section in a first direction. The second base is configured to at least partially overlap with the first base after folding the fourth fold section in the first direction.

### TECHNICAL FIELD

The present disclosure relates to the field of near-eye display technologies, and in particular to a near-eye display module and a near-eye display device.

### BACKGROUND

Intelligent near-eye display devices with augmented reality (AR), virtual reality (VR), or mixed reality (MR), such as AR glasses, VR glasses, or the like, may provide digital experiences to users, such as a visual experience with content display, an auditory experience with audio transmission, or the like. The augmented reality may superimpose virtual information on a physical world. A near-eye display device or a near-eye display module allows pixels on the display to form a distant virtual image through a series of optical imaging elements and projects the distant virtual image into the human eye. In related art, the internal structure design of the near-eye display module is unreasonable, and the near-eye display module has a relatively large volume and a relatively heavy weight, so that it is not convenient for long-term wearing the near-eye display device.

### SUMMARY OF THE DISCLOSURE

The present disclosure provides a near-eye display module including a housing, a control plate assembly, a display assembly, and a storage assembly.

The housing defines an installation space.

The control plate assembly is disposed in the installation space, the control plate assembly includes a main control plate and an adapter plate, and the adapter plate is connected to a side edge of the main control plate.

The display assembly is disposed in the installation space and electrically connected to the control plate assembly. The display assembly includes a first base, a second base, and a micro-display disposed on the first base. The first base is connected to the second base.

The storage assembly is disposed in the installation space and electrically connected to the display assembly. The storage assembly includes a second plate body, a first plate body, and a storage chip disposed on the first plate body. The second plate body is connected to the first plate body, and the first plate body is configured to be non-parallel to the second plate body after folding a fifth fold section.

The adapter plate is configured to at least partially overlap with the main control plate in a first direction after folding a first fold section, and the second base is configured to at least partially overlap with the first base in the first direction after folding a fourth fold section; the second plate body is configured to be located between the main control plate and the second base, and allow the storage chip to be electrically connected to the micro-display. The first base and the second base are configured to clamp the adapter plate and allow the micro-display to be electrically connected to the main control plate. The light-emitting surface of the micro-display is opposite to the adapter plate in the first direction.

The present disclosure further provides a near-eye display device including a frame, a lens, and the near-eye display module as described above.

The lens is disposed on the frame.

The near-eye display module is assembled on the frame and/or the lens.

### BRIEF DESCRIPTION OF THE DRAWINGS

In order to more clearly illustrate the technical solutions in some embodiments of the present disclosure or in the related art, hereinafter, a brief introduction will be given to the accompanying drawings that are used in the description of some embodiments or the related art. Obviously, the accompanying drawings in the description below are merely some embodiments of the present disclosure. For those of ordinary skill in the art, other accompanying drawings may be obtained based on these accompanying drawings without any creative efforts.

FIG. 1 is an exploded schematic view of a near-eye display module in some embodiments of the present disclosure.

FIG. 2 is a three-dimensional structural schematic view of the near-eye display module in some embodiments of the present disclosure.

FIG. 3 is a top view of the near-eye display module in some embodiments of the present disclosure.

FIG. 4 is a cross-sectional structural schematic view of the near-eye display module of FIG. 3 in an A-A direction.

FIG. 5 is a cross-sectional structural schematic view of the near-eye display module of FIG. 3 in a B-B direction.

FIG. 6 is a structural schematic view of a display assembly in some embodiments of the present disclosure.

FIG. 7 is another structural schematic view of the display assembly in some embodiments of the present disclosure.

FIG. 8 is a structural schematic view of a storage assembly in some embodiments of the present disclosure.

FIG. 9 is another structural schematic view of the storage assembly in some embodiments of the present disclosure.

FIG. 10 is a structural schematic view of a control plate assembly in some embodiments of the present disclosure.

FIG. 11 is another structural schematic view of the control plate assembly in some embodiments of the present disclosure.

FIG. 12 is yet another structural schematic view of the control plate assembly in some embodiments of the present disclosure.

FIG. 13 is yet another structural schematic view of the control plate assembly in some embodiments of the present disclosure.

FIG. 14 is a partial structural schematic view of the near-eye display module in some embodiments of the present disclosure.

FIG. 15 is a partial structural schematic view of the near-eye display module in another viewing angle in some embodiments of the present disclosure.

FIG. 16 is a structural schematic view of a near-eye display device in some embodiments of the present disclosure.

FIG. 17 is a partial exploded schematic view of the near-eye display device in some embodiments of the present disclosure.

FIG. 18 is a cross-sectional structural schematic view of the near-eye display module in some embodiments of the present disclosure.

FIG. 19 is a partial structural schematic view of the near-eye display module in some embodiments of the present disclosure.

FIG. 20 is another cross-sectional structural schematic view of the near-eye display module in some embodiments of the present disclosure.

FIG. 21 is the partial structural schematic view of the near-eye display module in some embodiments of the present disclosure.

### DETAILED DESCRIPTION

The present disclosure may be explained in detail by combining the accompanying drawings and some embodiments. The following embodiments are used to illustrate the present disclosure, but cannot be used to limit the scope of the present disclosure.

In the description of the present disclosure, the directions or positional relationships indicated by the terms, “center”, “longitudinal”, “transverse”, “up”, “down”, “front”, “back”, “left”, “right”, “vertical”, “horizontal”, “top”, “bottom”, “inside”, “outside”, etc. are based on the methods or positional relationships shown in the accompanying drawings. It is only intended to facilitate the description of the embodiments of the present disclosure and simplify the description, but does not indicate or imply that the device or the element referred to must have a specific orientation, be constructed and operated in a specific orientation. Therefore, it cannot be understood as a limitation on the embodiments of the present disclosure. The terms “first”, “second”, and “third” in the present disclosure are only configured to describe purposes and cannot be understood as indicating or implying relative importance.

In the description of the present disclosure, it should be noted that unless otherwise expressly specified and limited, the terms “connecting” and “connection” should be broadly understood. For example, it may be a fixed connection, a detachable connection, or an integrated connection; it may be a mechanical connection or an electrical connection; it may be a direct connection or an indirect connection through an intermediate medium. For those of ordinary skill in the art, the specific meanings of the above term may be understood according to specific circumstances.

In the embodiments of the present disclosure, unless otherwise expressly specified and limited, a first feature is above or below a second feature, which means that the first feature is in direct contact with the second feature, or the first feature is in indirect contact with the second feature through an intermediate medium. Moreover, the first feature is above the second feature, which may indicate that the first feature may be directly above or diagonally above the second feature, or simply indicate that a horizontal height of the first feature is higher than that of the second feature. The first feature is below the second feature, which may indicate that the first feature may be directly below or diagonally below the second feature, or simply indicate that the horizontal height of the first feature is lower than that of the second feature.

In the description of the present disclosure, the reference terms “an embodiment”, “some embodiments”, “examples”, “specific examples”, or “some examples” mean that specific features, structures, materials, or features described in conjunction with the embodiments or examples may be included in at least one embodiment or example of the present disclosure. In the present specification, the illustrative expressions of the above terms do not necessarily refer to the same embodiments or examples. Moreover, the specific features, structures, materials, or characteristics described may be combined in an appropriate manner in any one or more embodiments or examples. In addition, without mutual contradiction, those of skilled in the art may combine the different embodiments or examples, and combine the features of the different embodiments or examples described in the present specification.

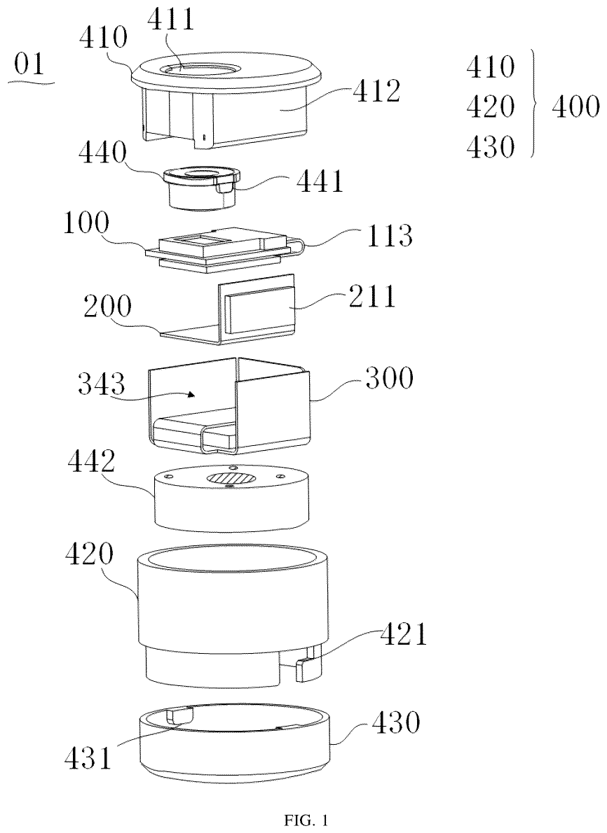

A near-eye display module and a near-eye display device of the present disclosure may be described in conjunction with FIGS. 1-21.

As illustrated in FIG. 1, the near-eye display module 01 in the present disclosure includes a housing 400, a control plate assembly 300, a storage assembly 200, and a display assembly 100. In order to facilitate the understanding of the relevant structures of the core components, the relevant electrical elements have been omitted from the relevant figures, such as a resistor, a capacitor, a chip, an inductor, or the like, which has not been marked.

The housing 400 defines an installation space 401. The entire housing 400 may be a pillar, such as a cylinder, a prism, a circular platform, or the like. A radial diameter of the housing 400 is less than or equal to 18 mm, such as 18 mm, 17 mm, 16 mm, 15 mm, 14 mm, 13 mm, 12 mm, 11 mm, 10 mm, 9 mm, 8 mm, 7 mm, or the like. A height of the housing 400 is less than or equal to 18 mm, such as 18 mm, 17 mm, 16 mm, 15 mm, 14 mm, 13 mm, 12 mm, 11 mm, 10 mm, 9 mm, 8 mm, 7 mm, or the like. The control plate assembly 300 is located in the installation space 401. The control plate assembly 300 is explained in detail below.

The control plate assembly 300 includes a main control plate 310 and an adapter plate 320. The adapter plate 320 is connected to a side edge of the main control plate 310. The adapter plate 320 is physically connected or mechanically connected to the main control plate 310, and the adapter plate 320 is also electrically connected to the main control plate 310. The main control plate 310 may be provided with a main control unit 3111 and multiple main control sub-elements 3112. The adapter plate 320 may be provided with electrical connection bits, such as electrical sockets, slots, electrical contact points, or the like.

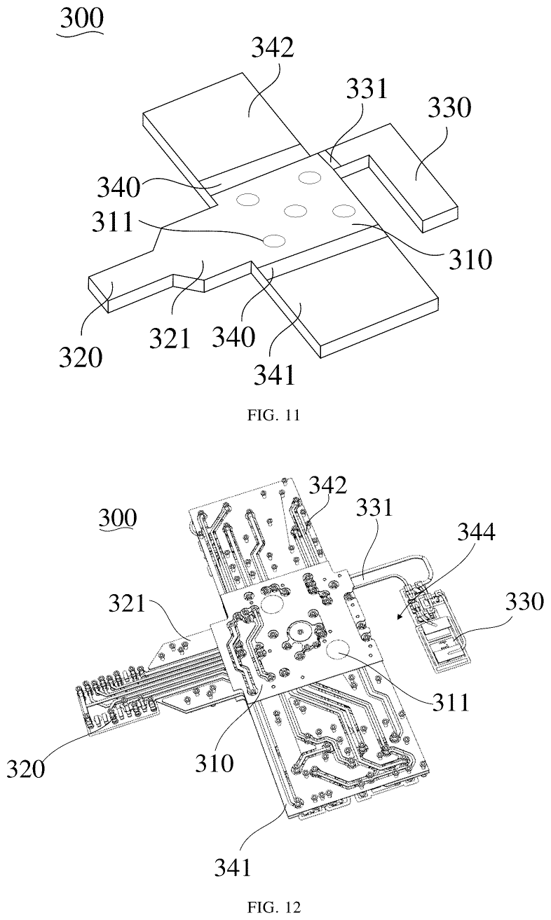

As illustrated in FIGS. 10 and 11, a perspective of FIG. 11 is opposite to that of FIG. 10. For example, FIG. 10 is a structural schematic view of the control plate assembly 300 from a front view, and FIG. 11 is a structural schematic view from a back view.

The control plate assembly 300 includes the main control plate 310, the adapter plate 320, an antenna plate 330, and a power plate. The power plate can include a first power plate 341 and a second power plate 342.

The adapter plate 320 is connected to the main control plate 310 through a first fold section 321. The first fold section 321 is configured to be foldable, so that a relative position between the adapter plate 320 and the main control plate 310 may be changed by folding the first fold section 321. The adapter plate 320 is provided with a first connection bit 322 that is configured for connecting an external element, such as, the display assembly 100. An electronic element on the main control plate 310 is electrically connected to the first connection bit 322. The first connection bit 322 is disposed on the adapter plate 320 that may be movable relative to the main control plate 310, thereby avoiding a thickness of the main control plate 310 from being too large. During assembling the control plate assembly 300 onto an overall device, such as the near-eye display module 01, a position of the adapter plate 320 may be flexibly changed through the first fold section 321. On the one hand, it may avoid the overall device from being too large in a single direction, and on the other hand, the control plate assembly 300 is more compatible with the installation environment. In addition, during soldering the electronic element, due to the separation of the first connection bit 322 and the main control plate 310, the operating space is larger in the process of soldering, thus, it is easier to solder. The first connection bit 322 may include a soldering point or an electrical socket. Alternatively, the first connection bit 322 may include both the soldering point and the electrical socket.

The antenna plate 330 is connected to the main control plate 310 through a second fold section 331. The second fold section 331 is configured to be foldable, so that a relative position between the antenna plate 330 and the main control plate 310 may be changed by folding the second fold section 331. The antenna plate 330 is provided with an antenna 3301. The antenna 3301 is configured to communicate with an external device, such as a smartphone, a computer, a tablet, a pair of smart glasses, a watch, or the like. The near-eye display module 01 is configured to receive image content from the external device for display. The power plate is connected to the main control plate 310 through a third fold section 340. The third fold section 340 is configured to be foldable, so that a relative position between the power plate and the main control plate 310 may be changed by folding the third fold section 340. The power plate may adjust a current and a voltage output from a power supply, so as to apply the current and the voltage to electronic elements on the control plate assembly 300.

The control plate assembly 300 has a first state and a second state. By unfolding or folding the first fold section 321, the second fold section 331, and the third fold section 340, the relative position between the main control plate 310 and the adapter plate 320, the relative position between the main control plate 310 and the antenna plate 330, the relative position between the main control plate 310 and the first power plate 341, and the relative position between the main control plate 310 and the second power plate 342 may be changed, so as to switch the control plate assembly 300 between the first state and second state. As illustrated in FIGS. 10 and 11, in the first state, the first fold section 321, the second fold section 331, and the third fold section 340 are all unfolded, that is entire control plate assembly 300 is unfolded. The adapter plate 320, the first power plate 341, the second power plate 342, the antenna plate 330, and the main control plate 310 are all on the same plane, which facilitates the installation of the electronic elements on the main control plate 310, the adapter plate 320, the first power plate 341, the second power plate 342, and the antenna plate 330.

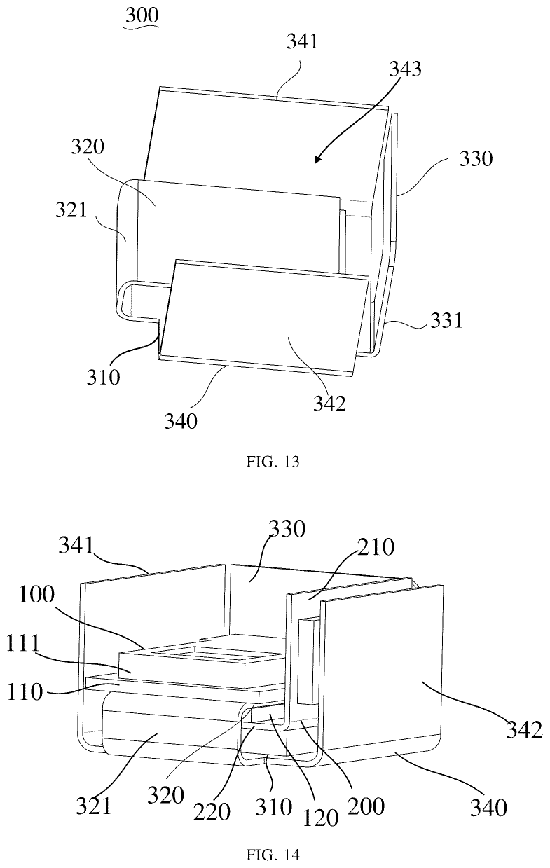

As illustrated in FIG. 13, in the second state, the first fold section 321, the second fold section 331, and the third fold section 340 are all folded, that is the entire the control plate assembly 300 is folded. The adapter plate 320, the power plate, and the antenna plate 330 are all located on a side of the main control plate 310. The main control plate 310 and at least one of the adapter plate 320, the power plate, and the antenna plate 330 forms an angle greater than 0 degrees, so as to form an accommodation space 343. The external element is located in the accommodation space 343. Thus, the control plate assembly 300 is switched to be in the second state, so that a structure with a three-dimensional space is formed, thereby reducing a size of the control plate assembly 300 on a plane where the main control plate 310 is located. The main control plate 310 and at least one of the adapter plate 320, the power plate, and the antenna plate 330 forms an angle greater than 0 degrees, thereby forming the accommodation space 343 configured for accommodating the external element, which avoids the adapter plate 320, the power plate, and the antenna plate 330 from being stacked on each other in a thickness direction of the main control plate 310. Stacking the adapter plate 320, the power plate, and the antenna plate 330 on each other in the thickness direction of the main control plate 310 may cause the control plate assembly 300 to be too thick after connecting the external element to the control plate assembly 300. Thus, forming the accommodation space 343 may avoid the overall thickness of the control plate assembly 300 from being too large after connecting the external element to the control plate assembly 300. After folding the fold sections, the adapter plate 320, the power plate, and the antenna plate 330 are all located on the same side of the main control plate 310, which means that after folding the fold sections, the adapter plate 320, the power plate, the antenna plate 330, and the main control plate 310 are not on the same plane. The angle between the main control plate 310 and each of the adapter plate 320, the power plate, the antenna plate 330 is less than 180 degrees.

In some embodiments of the present disclosure, the entire control plate assembly 300 is folded by folding the first fold section 321, the second fold section 331, and the third fold section 340, so that the structure with the three-dimensional space is formed, thereby reducing the size of the control plate assembly 300 on a single plane. The main control plate 310 and at least one of the adapter plate 320, the power plate, and the antenna plate 330 forms the angle greater than 0 degrees, thereby forming the accommodation space 343 configured for accommodating the external element, which avoids the adapter plate 320, the power plate, and the antenna plate 330 from being stacked on each other in the thickness direction of the main control plate 310, and avoids the overall thickness of the control plate assembly 300 from being too large after connecting the external element to the control plate assembly 300, thereby optimizing the spatial layout. In addition, the first connection bit 322 is disposed on the adapter plate 320 and separated from the main control plate 310. On the one hand, it may avoid the size of the near-eye display module 01 from being too large in the single direction after assembling the control plate assembly 300 on the near-eye display module 01. On the other hand, the control plate assembly 300 is more compatible with the installation environment. During soldering the electronic element, due to the separation of the first connection bit 322 and the main control plate 310, the operating space is larger in the process of soldering, which is easier to solder.

In some embodiments of the present disclosure, each of the main control plate 310, the antenna plate 330, the power plate, and the adapter plate 320 includes a first surface and a second surface opposite to the first surface. As illustrated in FIGS. 10 and 11, the first connection bit 322 is disposed on the first surface of the adapter plate 320, and the second surface of the adapter plate 320 is free of any element. As illustrated in FIG. 13, the first surface of the adapter plate 320 is configured to face the first surface of the main control plate 310 after folding the first fold section 321. The first surface of the main control plate 310 faces the accommodation space 343, and the second surface of the main control plate 310 is opposite to or away from the accommodation space 343. The main control unit 3111 and the main control sub-elements 3112 are disposed on the first surface of the main control plate 310. The power connection bit 311 is disposed on the second surface of the main control plate 310, and the power connection bit 311 is configured to be electrically connected to a battery 442, so that power supply is performed. The power connection bit 311 includes a first polarity electrical contact point and a second polarity electrical contact point surrounding the first polarity electrical contact point. One of the first polarity electrical contact point and the second polarity electrical contact point is a positive electrode, and the other of the first polarity electrical contact point and the second polarity electrical contact point is a negative electrode, which correspond to a positive electrode and a negative electrode of the battery 442.

Multiple power sub-elements 3411 are disposed on the first surface of the power plate, and the second surface of the power plate is free of any element. The first surface of the power plate is configured to form an angle with the first surface of the main control plate 310 after folding third fold section 340. The antenna 3301 is located on the first surface of the antenna plate 330 or the second surface of the antenna plate 330. The first surface of antenna plate 330 is configured to form an angle with the first surface of the main control plate 310 after folding the second fold section 331.

In some embodiments of the present disclosure, an area of each of the adapter plate 320 and the antenna plate 330 is smaller than that of the second power plate 342 or that of the first power plate 341. An area of the main control plate 310 is greater than that of the second power plate 342 or that of the first power plate 341. Each of the area of the second power plate 342, the area of the first power plate 341, the area of the main control plate 310, and the area of the antenna plate 330 is greater than each of the area of the second fold section 331 and the area of the third fold section 340.

As illustrated in FIG. 11, in some embodiments of the present disclosure, each of the first fold section 321, the second fold section 331, and the third fold section 340 includes a flexible circuit plate. A width of the second fold section 331 is less than that of the first fold section 321, and the width of the first fold section 321 is less than that of the third fold section 340.

As illustrated in FIGS. 11 and 12, FIGS. 11 and 12 are schematic views from the same view. The second fold section 331 is connected to a side edge of the main control plate 310. A width of the second fold section 331 is less than a length of the side edge of the main control plate 310 that is connected to the second fold section 331, so as to form an avoidance gap 344 between the main control plate 310 and the antenna plate 330. Thus, as illustrated in FIG. 12, after folding the second fold section 331, there is still the avoidance gap 344 between the antenna plate 330 and the main control plate 310, so that the external element may pass though the avoidance gap 344, thereby avoiding interference between the antenna plate 330 and external element in the accommodation space 343.

As illustrated in FIGS. 12 and 13, in some embodiments of the present disclosure, the main control plate 310 has a first side edge and a second side edge opposite to each other. The first fold section 321 is connected to the first side edge of the main control plate 310, and the second fold section 331 is connected to the second side edge of the main control plate 310. The width of the second fold section 331 is less than the length of the second side edge of the main control plate 310. In the second state, the adapter plate 320 is opposite to the antenna plate 330, that is, the avoidance gap 344 is opposite to the first side edge where the adapter plate 320 is located. Thus, a part of the external element connected to the first connection bit 322 may pass through the avoidance gap 344, so as to avoid interference between the antenna plate 330 and the external element.

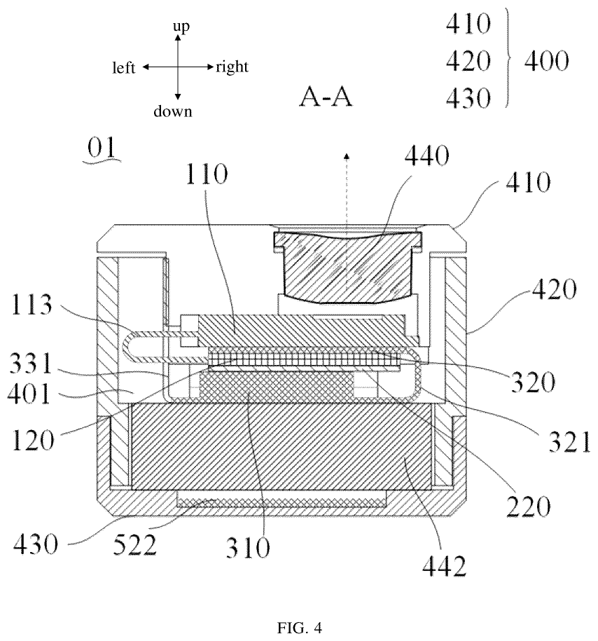

As illustrated in FIG. 13, in some embodiments of the present disclosure, the first fold section 321 is in a strip shape. In the second state, the first fold section 321 is folded, and the adapter plate 320 is located in the accommodation space 343. The adapter plate 320 overlaps with at least a part of the main control plate 310 in a first direction, and the first direction is along a height direction of the control plate assembly 300 (i.e., an up-down direction as illustrated in FIG. 4). The adapter plate 320 is opposite to and spaced apart from the main control plate 310. In this case, the first connection bit 322 faces the main control plate 310. Alternatively, the first connection bit 322 is opposite to or away from the main control plate 310. Thus, in response to the first connection bit 322 being connected to the external element, the external element may be in direct contact with the main control plate 310 to provide support, making the connection more stable. The adapter plate 320 is spaced apart from the main control plate 310, so that a part of the external element may be sandwiched between the adapter plate 320 and the main control plate 310. As illustrated in FIG. 4, in some embodiments, in the second state, the adapter plate 320 is parallel or approximately parallel to the main control plate 310, and the first connection bit 322 is located on a side surface of the adapter plate 320 facing the main control plate 310.

As illustrated in FIG. 12, in some embodiments of the present disclosure, the adapter plate 320, the power plate, and antenna plate 330 are distributed at intervals along a circumferential direction of the main control plate 310. Thus, after the first fold section 321, the second fold section 331, and the third fold section 340 are folded, the interference between every two of the adapter plate 320, the power plate, and the antenna plate 330 can be avoided. The interference among the adapter plate 320, the power plate, and the antenna plate 330 can be avoided.

As illustrated in FIGS. 10 and 13, in some embodiments of the present disclosure, the power plate includes the first power plate 341 and the second power plate 342. The first power plate 341 is connected to one side of the main control plate 310, and the second power plate 342 is connected to the other side of the main control plate 310. In the second state, the first power plate 341 and the second power plate 342 are opposite to each other. In some embodiments, the main control plate 310 is approximately in square shape and consists of the first power plate 341 and the second power plate 342. The first power plate 341, the adapter plate 320, the second power plate 342, and the antenna plate 330 are distributed at intervals along the circumferential direction of the main control plate 310. The first power plate 341 and the second power plate 342 are opposite to each other. In the first state, the first power plate 341 and the second power plate 342 are located on the same plane. In the second state, the first power plate 341 and the second power plate 342 are parallel or approximately parallel to each other. The adapter plate 320 and the antenna plate 330 are located on a pair of opposite sides of the main control plate 310, and the first power plate 341 and the second power plate 342 are located on the other pair of opposite sides of the main control plate 310.

The power sub-elements 3411 are disposed on the first surface of the first power plate 341, and the power sub-elements 3421 are disposed on the first surface of the second power plate 342. The power sub-elements 3411 and the power sub-elements 3421 may include resistors, capacitors, inductors, switching tubes, or amplifiers, or the like. The second surface of the first power plate 341 and the second surface of the second power plate 342 are free of any element. That is, the electronic elements on the first power plate 341 and the second power plate 342 are located on a side surface of the power plate facing the accommodation space 343. It ensures that the side surface of the power plate with the elements faces the accommodation space 343, and the side surface of the power plate without the elements faces the outer wall of the housing 400, thereby reducing damage to electrical elements during assembly. The first surface of the first power plate 341 and the first surface of the second power plate 342 are respectively configured to form an angle with the first surface of the main control plate 310 after folding the third fold sections 340. For example, each of the first surface of the first power plate 341 and the first surface of the second power plate 342 is perpendicular to the first surface of the main control plate 310, that is, the angle is 90 degrees. Alternatively, the angle is less than 90 degrees. In some embodiments, each of the surface of the first power plate 341 opposite to or away from the accommodation space 343, the surface of the second power plate 342 opposite to or away from the accommodation space 343, and the surface of the antenna plate 330 opposite to or away from the accommodation space 343 is provided with a reinforcement plate, so as to support the first power plate 341, the second power plate 342, and the antenna plate 330, thereby improving structural strengths of the first power plate 341, the second power plate 342, and the antenna plate 330.

As illustrated in FIG. 13, in the second state, the angle between the main control plate 310 and each of the first power plate 341, the second power plate 342, and the antenna plate 330 is greater than 0 degrees. The adapter plate 320 is parallel or approximately parallel to the main control plate 310, and the adapter plate 320 is spaced apart from the main control plate 310 by a certain distance. The first power plate 341, the second power plate 342, the antenna plate 330, and the main control plate 310 jointly define the accommodation space 343. The accommodation space 343 is approximately in cubic shape. The electronic element on the main control plate 310 is located on the side surface of the main control plate 310 facing the accommodation space 343, the electronic element on the power plate is located on the side surface of the power plate facing the accommodation space 343, and the electronic element on the antenna plate 330 may also be located on the side surface of the antenna plate 330 facing the accommodation space 343, so as to protect the electronic elements. In some embodiments, each of the surface of the first power plate 341 opposite to or away from the accommodation space 343, the surface of the second power plate 342 opposite to or away from the accommodation space 343, and the surface of the antenna plate 330 opposite to or away from the accommodation space 343 is provided with the reinforcement plate, so as to support the first power plate 341, the second power plate 342, and the antenna plate 330, thereby improving the structural strengths of the first power plate 341, the second power plate 342, and the antenna plate 330.

As illustrated in FIG. 12, in some embodiments of the present disclosure, the power connection bit 311 is disposed on the main control plate 310, the power connection bit 311 is configured for being connected to the power source. The power source may be the battery. The power connection bit 311 includes a positive connection point and a negative connection point, and the positive connection point and the negative connection point are correspondingly connected to the electrical points of the power source. In the second state, the power connection bit 311 is located on the side surface of the main control plate 310 opposite to or away from the accommodation space 343, which facilitates the connection between the control plate assembly 300 and the power supply, and facilitates the corresponding connection between the positive and negative connection points and the electrical points of the power supply.

As illustrated in FIG. 14, in some embodiments of the present disclosure, the near-eye display module 01 includes both the display assembly 100 and the control plate assembly 300 as described above.

In some embodiments, the control plate assembly 300 is in the second state, and the display assembly 100 is located in the accommodation space 343. The display assembly 100 is provided with a control plate connection bit, the control plate connection bit is connected to the first connection bit 322. The external element mentioned above is the display assembly 100. By folding the first fold section 321, the second fold section 331, and the third fold section 340, the entire control panel assembly 300 is folded, so that the structure with the three-dimensional space is formed, thereby reducing the size of the control panel assembly 300 on the single plane. At least one of the adapter plate 320, the power plate, and the antenna plate 330 has an angle greater than 0 degrees with the main control plate 310, so that the accommodation space 343 configured for accommodating the external element is defined. It avoids the adapter plate 320, the power plate, and the antenna plate 330 from being stacked on each other in the thickness direction of the main control plate 310, thereby avoiding the overall thickness of the control plate assembly 300 from being too large after connecting the external element to the control panel assembly 300.

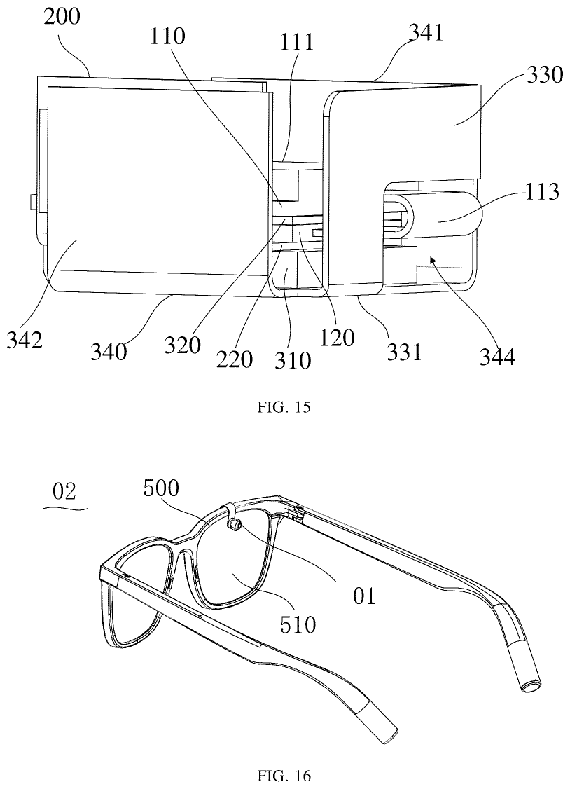

As illustrated in FIG. 14, the display assembly 100 has a first base 110 and a second base 120. The first base 110 is connected to the second base 120 by a fourth fold section 113. The fourth fold section 113 may be foldable, so as to stack the first base 110 and the second base 120 on each other. The display assembly 100 is connected to the control plate assembly 300, and the fourth fold section 113 is folded. The first base 110 is provided with a micro-display 111, and the second base 120 is provided with the control plate connection bit, and the control plate connection bit is located on a side surface of the second base 120 facing the first base 110. The adapter plate 320 is located between the first base 110 and the second base 120. The side surface of the adapter plate 320 with the first connection bit 322 faces the second base 120, and the first connection bit 322 may be directly connected to the control plate connection bit. Thus, the first base 110, the adapter plate 320, and the second base 120 are constructed in a stacked structure. As illustrated in FIGS. 4 and 15, during assembly, the fourth fold section 113 of the display assembly 100 protrudes from the first base 110 and the second base 120, and the fourth fold section 113 is configured for passing through the avoidance gap 344.

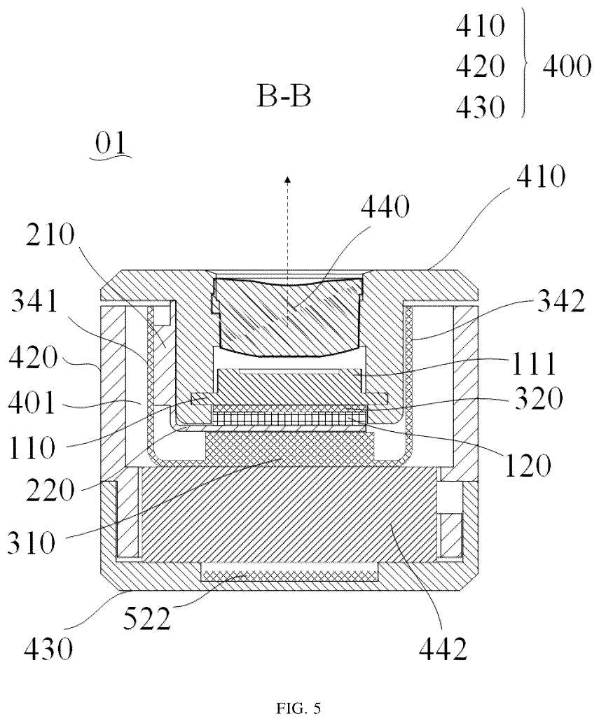

In some embodiments, the near-eye display module 01 further includes the housing 400 and the storage assembly 200. The housing 400 defines the installation space 401, and the display assembly 100, the control plate assembly 300, and the storage assembly 200 are located in the installation space 401. The storage assembly 200 is connected to the display assembly 100, and the storage assembly 200 is also disposed in the accommodation space 343. As illustrated in FIGS. 4 and 5, FIGS. 4 and 5 are cross-sectional structural schematic views of the near-eye display module 01, the cross-sections corresponding to FIGS. 4 and 5 are perpendicular to each other. The storage assembly 200 has a first plate body 210 and a second plate body 220. The storage assembly 200 is L-shaped, and the second plate body 220 is embedded between the display assembly 100 and the main control plate 310. A display connection bit is disposed on the second plate body 220, a storage connection bit is disposed on a side surface of the second plate body 220 opposite to or away from the first plate body 210 and the storage connection bit is connected to the display connection bit. The second plate body 220 may be attached or not attached on the main control plate 310, as long as there is no electrical short circuit be caused. The first plate body 210 is opposite to the first power plate 341 or the second power plate 342. The first plate body 210 may be attached or not attached on the first power plate 341 or the second power plate 342, as long as there is no electrical short circuit be caused. The accommodation space 343 is defined by the control plate assembly 300. The display assembly 100 and the storage assembly 200 are located in the accommodation space 343. The adapter plate 320 is disposed into the accommodation space 343 by folding the first fold section 321, so that the adapter plate 320 is connected to the display assembly 100, making full use of the space and avoiding the large volume of the near-eye display module 01 caused by arranging multiple components in the single direction. It facilitates the placement of the near-eye display module 01 on the smart glasses, reduces interference with the head by the near-eye display module 01, and improves wearing comfort. A top of the housing 400 defines a light-transmitting part 411, and a light-emitting surface 114 of the display assembly 100 faces the light-transmitting part 411. The optical assembly 440 is between the light-transmitting part 411 and the light-emitting surface 114. The optical assembly 440 is configured to receive light from the light-emitting surface 114, and allow the light to be reflected in the optical assembly 440 and then be emitted. As illustrated in FIGS. 5 and 14, a height of the display assembly 100 is less than that of the power plate. That is, a top surface of the micro-display 111 does not protrude from a top of the power plate, so as to facilitate the storage of other components. In some embodiments, a part of the optical assembly 440 may be disposed in the accommodation space 343, which may increase the first plate body 210 in the limited space inside the housing 400, thereby providing sufficient installation position for a storage chip 211, and avoiding the size of the near-eye display module 01 from being too large in the height direction.

The display assembly 100 is disposed in the installation space 401 and electrically connected to the control plate assembly 300. The display assembly 100 is explained in detail below.

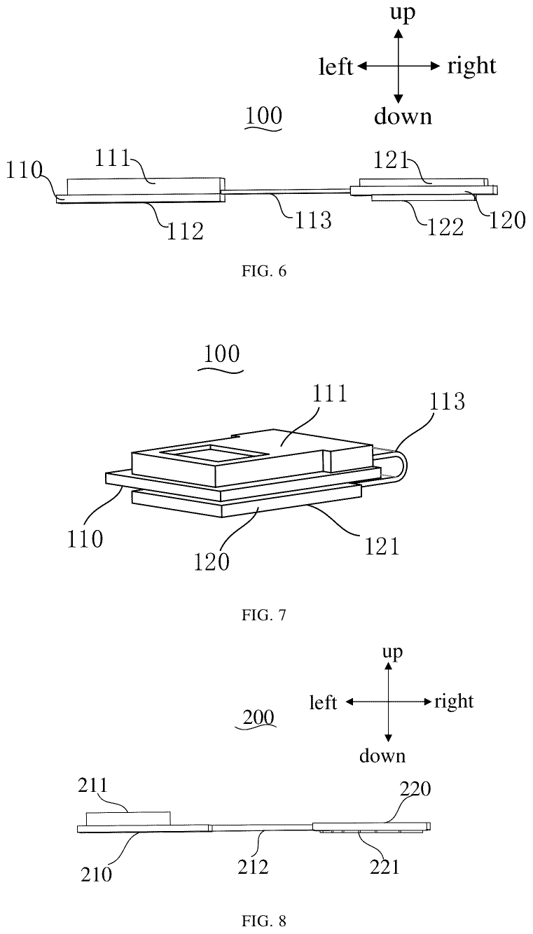

As illustrated in FIG. 6, the display assembly 100 in some embodiments of the present disclosure includes the first base 110, the second base 120, the micro-display 111, and the fourth fold section 113.

The micro-display 111 is disposed on the first base 110, and a fourth connection bit 121 and a second connection bit 122 are disposed on the second base 120. The fourth connection bit 121 is located on a side surface of the second base 120, and the second connection bit 122 is located on a side surface of the second base 120 opposite to the side surface where the fourth connection bit 121 is located. That is, the second base 120 includes two opposite side surfaces, the fourth connection bit 121 is located on one of the two opposite side surfaces, and the second connection bit 122 is located on the other of the two opposite side surfaces. The micro-display 111 is electrically connected to the fourth connection bit 121 and the second connection bit 122. The fourth connection bit 121 and the second connection bit 122 are configured to connect the micro-display 111 to other elements. For example, the micro-display 111 is connected to a power supply device through the fourth connection bit 121. Each of the fourth connection bit 121 and the second connection bit 122 may include the soldering point and/or the electrical socket. As illustrated in FIG. 6, each of the first base 110 and the second base 120 may be in a plate shape.

The fourth fold section 113 connects the first base 110 to the second base 120. A wire may be disposed on the fourth fold section 113, or the fourth fold section 113 may be the wire, so that the micro-display 111 is connected to each of the fourth connection bit 121 and the second connection bit 122. The fourth fold section 113 is configured to be foldable, and the display assembly 100 is switchable between the first state and the second state. As illustrated in FIG. 6, in the first state, the fourth fold section 113 is unfolded, and the first base 110, the fourth fold section 113, and the second base 120 are connected in sequence and on the same straight line, so that the display assembly 100 is the flat-plate-shaped. In this case, the first base 110 is separated from the second base 120. The display assembly 100 is unfolded, which facilitates the installation of the micro-display 111, the fourth connection bit 121, and the second connection bit 122 on the first base 110 or the second base 120.

As illustrated in FIG. 7, in the second state, the fourth fold section 113 is folded, and the first base 110 and the second base 120 are stacked on each other. The fourth fold section 113 is folded, and the entire display assembly 100 is approximately in cubic shape, which facilitates assembly. In the second state, in response to the fourth connection bit 121 or the second connection bit 122 being located on the side surface of the second base 120 facing the first base 110, there may be a certain distance between the first base 110 and the second base 120, so that the external element is connected to the fourth connection bit 121 or the second connection bit 122. In response to the fourth connection bit 121 and the second connection bit 122 being not located on the side surface of the second base 120 facing the first base 110, the first base 110 may be spaced apart from or attached on the second base 120. During assembling the display assembly 100 to the near-eye display module 01, the fourth fold section 113 is configured to be foldable, so that the display assembly 100 is switched to the second state.

In the display assembly 100 of the present disclosure, the connection position of the micro-display 111 is spaced apart from the connection position of the fourth connection bit 121 by disposing the first base 110, and the connection position of the micro-display 111 is spaced apart from the connection position of the second connection bit 122 by disposing the second base 120. In the first state, the display assembly 100 is unfolded, which facilitates soldering and installation of the micro-display 111 on the fourth connection bit 121 and soldering and installation of the micro-display 111 on the second connection bit 122 during the manufacturing process. The display assembly 100 may be switched to the second state by folding the fourth fold section 113. The fourth fold section 113 is folded, so that the first base 110 and the second base 120 may be stacked on each other by folding the fourth fold section 113. The micro-display 111 is separated from the fourth connection bit 121 and the second connection bit 122, which facilitates assembly and breaks the limitations of a single base structure, thereby increasing space utilization, making space arrangement more flexible, and avoiding assembly inconvenience caused by excessive size of the display assembly 100 in the single direction.

In some embodiments of the present disclosure, an area of the fourth connection bit 121 and an area of the second connection bit 122 are smaller than an area of the first base 110 and an area of the second base 120. That is, in the second state, both an orthographic projection of the fourth connection bit 121 on a plane of the first base 110 and an orthographic projection of the second connection bit 122 on the plane of the first base 110 are completely located on the first base 110. The fourth connection bit 121 and the second connection bit 122 do not protrude from the second base 120 in the circumferential direction. The area of the fourth connection bit 121 is greater than or equal to the area of the second connection bit 122. One of the fourth connection bit 121 and the second connection bit 122 is a storage chip soldering bit that is configured for being electrical connected to the storage chip 211. The other of the fourth connection bit 121 and the second connection bit 122 is a control plate soldering bit that is configured for being connected to the main control plate 310.

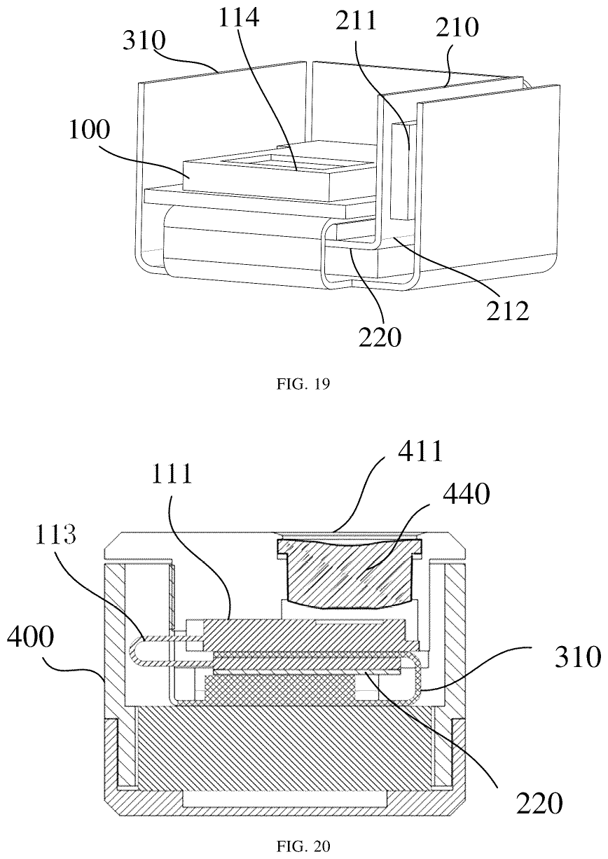

As illustrated in FIG. 20, in some embodiments of the present disclosure, the near-eye display module 01 includes the housing 400, the main control plate 310, the storage assembly 200, and the display assembly 100.

The housing 400 defines the installation space 401. The main control plate 310, the storage assembly 200, and the display assembly 100 are located in the installation space 401. The housing 400 is provided with the light-transmitting part 411, and the light-transmitting part 411 faces the display assembly 100. The display assembly 100 projects a virtual image outward through the light-transmitting part 411. The display assembly 100 is connected to the main control plate 310 and the storage assembly 200. The main control plate 310 is provided with a first display connection bit 302, and the first display connection bit 302 is configured to be connected to the display assembly 100. The storage assembly 200 is provided with a second display connection bit 202, and the storage chip 211 is disposed on the storage assembly 200. The storage chip 211 is connected to the display assembly 100 through the second display connection bit 202. The display assembly 100 is in the second state, that is, the display assembly 100 in the second state is connected to other elements of the near-eye display module 01. The fourth connection bit 121 is connected to the second display connection bit 202, and the second connection bit 122 is connected to the first display connection bit 302. The above connection relationship may be soldering.

The micro-display 111 is separated from the fourth connection bit 121 and the second connection bit 122, which facilitates assembly and breaks the limitations of using the single base structure for the display assembly 100, thereby increasing space utilization, making space arrangement more flexible, and avoiding the large size of the near-eye display module 01 caused by the excessive size of the display assembly 100 in the single direction. Thus, the comfort of users wearing the AR glasses or VR glasses with the near-eye display module 01 is improved.

As illustrated in FIG. 20, in some embodiments of the present disclosure, the near-eye display module 01 further includes the optical assembly 440 that is disposed in the installation space 401. The optical assembly 440 is located between the display assembly 100 and the light-transmitting part 411. An optical axis of the micro-display 111, an optical axis of the optical assembly 440, and a central axis of the light-transmitting part 411 are on the same straight line. The optical assembly 440 is located on a side of the micro-display 111 opposite to or away from the first base 110. The optical assembly 440 is spaced apart from the micro-display 111. The optical assembly 440 is configured to receive the light from the micro-display 111, and allow the light to be reflected in the optical assembly 440 and then be emitted.

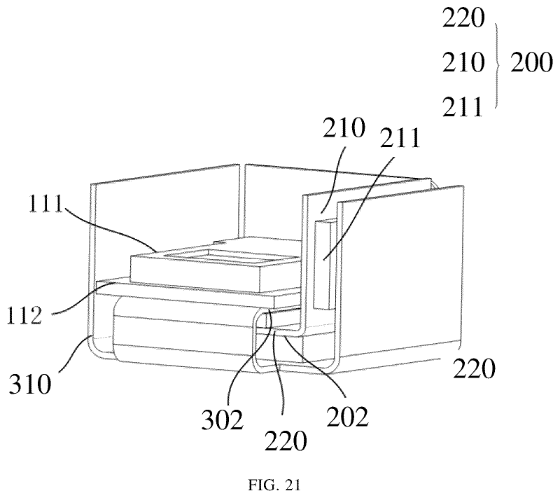

As illustrated in FIG. 21, in some embodiments of the present disclosure, the storage assembly 200 includes the second plate body 220, the first plate body 210, and the storage chip 211 disposed on the first plate body 210. The second display connection bit 202 is disposed on the second plate body 220. The second display connection bit 202 is electrically connected to the storage chip 211, so that the storage chip 211 is connected to the micro-display 111 through the second display connection bit 202 and the fourth connection bit 121.

The second plate body 220 is connected to the first plate body 210, and the first plate body 210 is configured to be non-parallel to the second plate body 220 after folding the fifth fold section 212. The first plate body 210 and the second plate body 220 form an angle, and the accommodation space 343 is defined by the second plate body 220 and the first plate body 210. The display assembly 100 is located in the accommodation space 343, and the display assembly 100 is stacked with the second plate body 220. The second display connection bit 202 may be disposed on the side surface of the second plate body 220 facing the accommodation space 343. The display assembly 100 is in the second state, the fourth connection bit 121 is located on the side surface of the second base 120 opposite to or away from the first base 110. During stacking the display assembly 100 with the second plate body 220, the fourth connection bit 121 is in direct contact with the second display connection bit 202. The height of the micro-display 111 is less than that of the first plate body 210. That is, the position of the light-emitting surface 114 of the micro-display 111 is lower than the top of the first plate body 210. The optical assembly 440 may be disposed in the accommodation space 343, thereby reducing the size of the near-eye display module 01 in the height direction.

In some embodiments of the present disclosure, the second base 120 has two opposite side surfaces. The fourth connection bit 121 is located on one of the two opposite side surfaces, and the second connection bit 122 is located on the other of the two opposite side surfaces. In the first state, the display assembly 100 includes two opposite sides, the micro-display 111 and the fourth connection bit 121 are located on one of the two opposite sides, and the second connection bit 122 is located on the other side of the two opposite sides. That is, the micro-display 111 and the fourth connection bit 121 are located on the same side of the display assembly 100. Thus, during assembling the micro-display 111, the fourth connection bit 121, and the second connection bit 122, there is no need to frequently flip the first base 110 and the second base 120, which improves operation efficiency. In some embodiments, as illustrated in FIG. 6, the first base 110 and the second base 120 may both be in a plate-shaped. In the first state, the display assembly 100 is the flat-plate-shaped, and the first base 110 and the second base 120 are parallel or approximately parallel to each other. The micro-display 111 may be located on a top surface of the first base 110 (as illustrated in FIG. 6), the fourth connection bit 121 is located on a top surface of the second base 120, and the second connection bit 122 is located on a bottom surface of the second base 120.

In the second state, the first base 110 and the second base 120 are spaced apart from each other and configured to accommodate the external element. That is, there is a certain distance between the first base 110 and the second base 120, so that the external element is disposed between the first base 110 and the second base 120. The second connection bit 122 faces the first base 110, and the fourth connection bit 121 is opposite to or away from the first base 110. The first base 110 is located between the micro-display 111 and the second base 120, and the micro-display 111 is located on the side of the first base 110 opposite to or away from the second base 120. In some embodiments, the external element connected to the display assembly 100 may be disposed between the first base 110 and the second base 120. In this case, the fourth connection bit 121 or the second connection bit 122 may be disposed on the side surface of the second base 120 facing the first base 110, so as to directly connect with the external element, thereby reducing the number of connecting elements and saving space. As illustrated in FIG. 7, in the second state, the micro-display 111 is opposite to or away from the second base 120.

In some embodiments of the present disclosure, the fourth fold section 113 includes the flexible circuit plate. In the first state, the fourth fold section 113 is in a strip shape. The fourth fold section 113 is parallel or approximately parallel to the first base 110, and the fourth fold section 113 and the second base 120 are in the straight line, so that the display assembly 100 is the flat-plate-shaped. In the second state, the fourth fold section 113 is connected to the same side of the first base 110 and the second base 120, and the fourth fold section 113 is U-shaped.

As illustrated in FIGS. 6 and 7, in some embodiments of the present disclosure, one end of the fourth fold section 113 is connected to a side wall of the first base 110, and the other end of the fourth fold section 113 is connected to a side wall of the second base 120. A width of the fourth fold section 113 is less than that of the first base 110 and less than that of the second base 120, so as to reduce the space occupied by the fourth fold section 113 and facilitate storage.

As illustrated in FIGS. 7 and 20, in some embodiments of the present disclosure, a thickness of the first base 110 is defined as L1, a gap between the first base 110 and the second base 120 is defined as L2, and a length of the fourth fold section 113 is greater than L1+L1, so that the fourth fold section 113 has a sufficiently long length. In the second state, a distance between the first base 110 and the second base 120 may be adjusted in a large range, which facilitates the placement of the external element between the first base 110 and the second base 120.

As illustrated in FIGS. 7 and 20, in the second state, the fourth connection bit 121 is located on the side surface of the second base 120 opposite to or away from the first base 110, and the second connection bit 122 is located on the side surface of the second base 120 facing the first base 110. The fourth connection bit 121 is the control plate soldering bit, and the second connection bit 122 is the chip soldering bit. The part of the main control plate 310 with the first display connection bit 302 may be folded, so that the part of the main control plate 310 with the first display connection bit 302 is disposed in a connection space.

As illustrated in FIGS. 6 and 20, the display assembly 100 further includes a first reinforcement sheet 112. The first reinforcement sheet 112 is disposed on the side surface of the first base 110 opposite to or away from the micro-display 111, so as to support and protect the micro-display 111. As illustrated in FIG. 6, the first reinforcement sheet 112 is the plate-shaped. An area of a side surface of the first reinforcement sheet 112 facing the micro-display 111 is greater than that of a side surface of the micro-display 111, so that the orthographic projection of the micro-display 111 on a plane of the first reinforcement sheet 112 is located on the first reinforcement sheet 112. In some embodiments, the first reinforcement sheet 112 may be bonded to the first base 110 by an adhesive. Alternatively, the first reinforcement sheet 112 and the first base 110 may be integrated.

That is, the display assembly 100 includes the first base 110, the second base 120, and the micro-display 111 disposed on the first base 110. The first base 110 is connected to the second base 120. There may be physical and electrical connections between the first base 110 and the second base 120. The micro-display 111 may include, but is not limited to, a micro light-emitting diode (Micro-LED), a micro organic light-emitting diode (Micro-OLED), a liquid crystal on silicon (LCoS), a liquid crystal display (LCD), a digital micromirror device (DMD), a digital light processing (DLP), a laser beam scanning (LBS), or any combination thereof.

The storage assembly 200 is located in the installation space 401 and is electrically connected to the display assembly 100. The storage assembly 200 is explained in detail below.

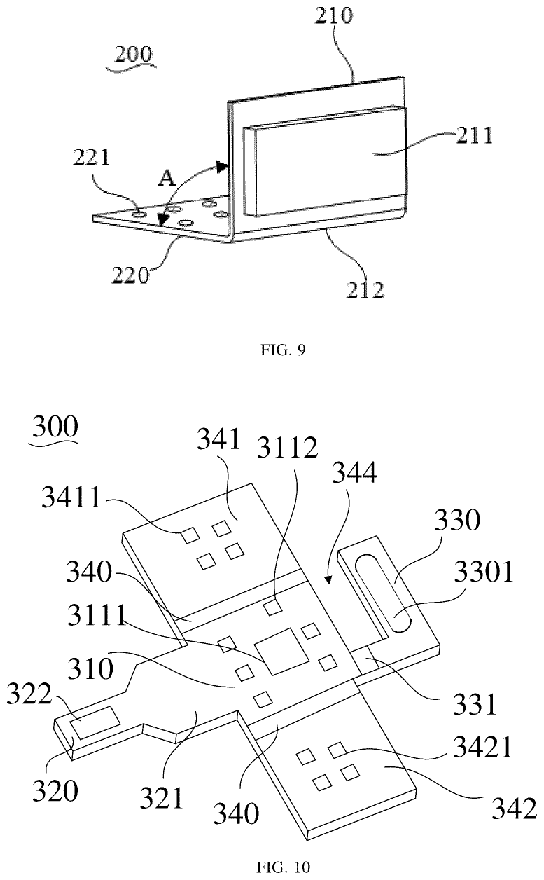

As illustrated in FIGS. 8 and 9, in some embodiments of the present disclosure, the storage assembly 200 includes the first plate body 210, the storage chip 211, the second plate body 220, and a fifth fold section 212.

The storage chip 211 is located on the first plate body 210, and a third connection bit 221 is disposed on the second plate body 220. The third connection bit 221 is connected to the storage chip 211. The third connection bit 221 is configured to be connected to the external element. In some embodiments, the third connection bit 221 may include multiple electrical contact points spaced apart from each other. The multiple electrical contact points are arranged in an array along the length and the width of the second plate body 220. The multiple electrical contacts are configured to be electrically connected to the external element and detachable from the external element.

The fifth fold section 212 connects the first plate body 210 to the second plate body 220. The fifth fold section 212 may be foldable, so that the storage assembly 200 may be switched between the unfolded state and the folded state. As illustrated in FIG. 8, in the unfolded state, the first plate body 210 and the second plate body 220 are on the same plane, and the first plate body 210 and the second plate body 220 are spaced apart from each other, which facilitates the soldering of the storage chip 211 on the first plate body 210 and the soldering of the third connection bit 221 on the second plate body 220. As illustrated in FIG. 8, in some embodiments, the first plate body 210, the fifth fold section 212, and the second plate body 220 are sequentially connected. In the unfolded state, the first plate body 210, the fifth fold section 212, and the second plate body 220 are in the straight line, and the storage assembly 200 is in the flat-plate-shaped. During switching to the folded state, the first plate body 210 is flipped relative to the second plate body 220 by a certain angle.

As illustrated in FIG. 9, in the folded state, the fifth fold section 212 is folded, thereby forming an angle between the first plate body 210 and the second plate body 220. The storage chip 211 and the third connection bit 221 are located on different planes, so as to fully utilize space and avoid the size of the storage assembly 200 from being too large in the single direction. The first plate body 210 and the second plate body 220 define the accommodation space 343 that is configured for accommodating the external element. A storage angle defined as A is formed between the first plate body 210 and the second plate body 220, wherein 0°<A<180°. As illustrated in FIG. 9, the storage angle A is 90 degrees. Thus, the storage assembly 200 is connected to the external element, and the external element may be disposed in the accommodation space 343 and in direct contact with the second plate body 220, which shortens a connection distance between the external element and the third connection bit 221. The external element may be directly connected to the third connection bit 221, thereby simplifying the connection wire.

In the storage assembly 200 of some embodiments of the present disclosure, the storage chip 211 is disposed on the first plate body 210, and the third connection bit 221 is disposed on the second plate body 220. The storage chip 211 is separated or spaced apart from the third connection bit 221. The fifth fold section 212 may be foldable, so that the storage assembly 200 may be in the unfolded state and the folded state. In the unfolded state, the first plate body 210 and the second plate body 220 are on the same plane, which facilitates the installation of the storage chip 211 and the third connection bit 221. In the folded state, the storage angle A is formed between the first plate body 210 and the second plate body 220, and the first plate body 210 and the second plate body 220 define the accommodation space 343 that is configured for accommodating the external element. Thus, the storage chip 211 and the third connection bit 221 are disposed on different planes, thereby making full use of space, avoiding the size of the storage assembly 200 from being too large in the single direction, and avoiding the excessive volume of the near-eye display module 01 caused by applying the storage assembly 200 to the near-eye display module 01.

In some embodiments of the present disclosure, each of the first plate body 210 and the second plate body 220 includes a first surface and a second surface opposite to each other. As illustrated in FIG. 9, in the folded state, the first surface of the first plate body 210 is configured to form the storage angle A with the first surface of the second plate body 220 after folding the fifth fold section 212. The first surface of the second plate body 220 is provided with the third connection bit 221, and the storage chip 211 is located on the first surface of the second plate body 220 or the second surface of the second plate body 220. As illustrated in FIG. 9, the storage chip 211 is located on the second surface of the second plate body 220, other elements may be disposed between the first surface of the first plate body 210 and the first surface of the second plate body 220. The third connection bit 221 is electrically connected to the storage chip 211 through the fifth fold section 212.

In some embodiments of the present disclosure, the fifth fold section 212 is the flexible circuit plate, so as to connect the storage chip 211 and the fifth fold section 212. The fifth fold section 212 is in the strip shape, and the length (i.e., the size along the left and right directions as illustrated in FIG. 8) of the fifth fold section 212 is less than the length of the first plate body 210 and the length of the second plate body 220. It avoids the fifth fold section 212 in the folded state from being too long, thereby facilitating storage and avoiding occupying space. The width of the fifth fold section 212 (perpendicular to the length direction of the fifth fold section 212) is less than or equal to the width of the first plate body 210 and the width of the second plate body 220. The fifth fold section 212 does not protrude from the first plate body 210 and the second plate body 220, thereby making the overall shape of the storage assembly 200 more regular. In some embodiments, the area of the fifth fold section 212 is smaller than that of the first panel 210 and that of the second panel 220, and the area of the first panel 210 is greater than or equal to that of the second panel 220.

In some embodiments of the present disclosure, in the unfolded state, the storage chip 211 is located on the second surface of the first plate body 210, and the third connection bit 221 is located on the first surface of the second plate body 220. As illustrated in FIG. 8, the storage chip 211 is located on the surface of the first plate body 210 facing upward (i.e., the direction as illustrated in FIG. 8), and the third connection bit 221 is located on the surface of the second plate body 220 facing downward. The storage chip 211 and the third connection bit 221 are located on different surface. After folding the fifth fold section 212, one of the storage chip 211 and the third connection bit 221 is located inside the accommodation space 343, and the other of the storage chip 211 and the third connection bit 221 is located outside the accommodation space 343. It may avoid interference between each two of the storage chip 211, the third connection bit 221, and the external element in the accommodation space 343 caused by both the storage chip 211 and the third connection bit 221 are disposed in the accommodation space 343. As illustrated in FIG. 9, in some embodiments, in the folded state, the storage chip 211 is located on the side surface of the first plate body 210 opposite to or away from the accommodation space 343, which avoids interference between the storage chip 211 and external element in the accommodation space 343. The third connection bit 221 is located in the accommodation space 343, which shortens the distance between the third connection bit 221 and the external element in the accommodation space 343, and facilitates connection. The third connection bit 221 may be directly connected to the external element.

The storage chip 211 and the third connection bit 221 may be located on the same side. In some embodiments, the storage chip 211 is located on the surface of the first plate body 210 facing downward, i.e., the bottom surface of the first plate body 210. The third connection bit 221 is located on the surface of the second plate body 220 facing upward, i.e., the top surface of the second plate body 220. The fifth fold section 212 is switched to the folded state, both the storage chip 211 and the third connection bit 221 may be located inside or outside the accommodation space 343, which may depend on the folding direction, thus it may be adapted to different installation environment of the storage assembly 200.

In some embodiments of the present disclosure, a second reinforcement sheet is disposed on the second plate body 220, and the second reinforcement sheet may be the plate-shaped. The second plate body 220 includes two opposite side surfaces, the third connection bit 221 is located on one of the two opposite side surfaces, and the second reinforcement sheet is located on the other of the two opposite side surfaces. That is, the third connection bit 221 and the second reinforcement sheet are respectively located on the two opposite side surfaces of the second plate body 220. The second reinforcement sheet may support and protect the third connection bit 221, and the second reinforcement sheet may be bonded to the second plate body 220 by the adhesive. The area of the side surface of the second reinforcement sheet connected to the second plate body 220 is greater than or equal to the area of the side surface of the second plate body 220 where the third connection bit 221 is located. In some embodiments, the second reinforcement sheet and the second plate body 220 are integrated.

As illustrated in FIG. 18, in some embodiments of the present disclosure, the near-eye display module 01 includes the display assembly 100 and the storage assembly 200.

The storage assembly 200 is in the folded state, and the accommodation space 343 is defined in the storage assembly 200. The display assembly 100 is connected to the storage assembly 200, so as to obtain image information stored in the storage assembly 200. The display assembly 100 is provided with the storage connection bit, and the storage connection bit is connected to the third connection bit 221. The display assembly 100 is located in the accommodation space 343, so that the storage connection bit is connected to the third connection bit 221. The storage assembly 200 is switched to the folded state and assembled into the near-eye display module 01, the display assembly 100 is disposed in the accommodation space 343. The third connection bit 221 and the storage chip 211 are disposed on different planes, making full use of the space of the storage assembly 200, thereby avoiding the overall volume of the near-eye display module 01 from being too large caused by the large size of the storage assembly 200 in the single direction.

In some embodiments, as illustrated in FIGS. 9 and 19, in response to the storage angle is 90 degrees, the plane of the storage chip 211 is perpendicular to the plane of the third connection bit 221. The third connection bit 221 is located in the accommodation space 343, and the storage chip 211 is located on the side surface of the first plate body 210 opposite to or away from the accommodation space 343. The display assembly 100 is disposed in the accommodation space 343 and connected to the third connection bit 221 on the second plate body 220. The thickness direction of the display is the same as that of the second plate body 220. The thickness direction of the storage chip 211 and the thickness direction of the first plate body 210 are perpendicular to the thickness direction of the second plate body 220, thereby avoiding excessive size of the storage assembly 200 in the single direction after the storage assembly 200 is connected to the display assembly 100, and reducing the volume of the near-eye display module 01.

As illustrated in FIG. 19, the display assembly 100 is parallel or approximately parallel to the second plate body 220, and the display assembly 100 is stacked with the second plate body 220. The storage connection bit is located on the side surface of the display assembly 100 facing the second plate body 220. After the display assembly 100 is installed in the accommodation space 343, the storage connection bit is in contact with the third connection bit 221 and is connected to the third connection bit 221. The display assembly 100 is spaced apart from the first plate body 210, and a light-emitting direction of the display assembly 100 is opposite to or away from the second plate body 220. As illustrated in FIGS. 18 and 19, the display assembly 100 has the light-emitting surface 114, and the light-emitting surface 114 is opposite to or away from the second plate body 220.

As illustrated in FIGS. 18 and 19, the near-eye display module 01 also includes the housing 400 and the main control plate 310. The housing 400 defines the installation space 401. The main control plate 310, the display assembly 100, and the storage assembly 200 are disposed in the installation space 401. The housing 400 includes the light-transmitting part 411, and the light-transmitting part 411 is opposite to the light-emitting surface 114 of the display assembly 100. The optical assembly 440 is disposed between the light-transmitting part 411 and the display assembly 100. The optical assembly 440 is configured to receive the light from the light-emitting surface 114, and allow the light to be reflected in the optical assembly 440 and then be emitted. The light emitted from the light-emitting surface 114 of the display assembly 100 projects the virtual image through the optical assembly 440 and the light-transmitting part 411. The main control plate 310 is connected to the display module 100. As illustrated in FIG. 19, the main control plate 310 may be folded and approximately in cubic shape. The storage assembly 200 and the display module 100 may be disposed inside the main control plate 310, so as to fully utilize the installation space 401 and reduce the volume of the near-eye display module 01.

As illustrated in FIGS. 18 and 19, in some embodiments, the height of the display assembly 100 is less than the height of the first plate body 210. That is, the light-emitting surface 114 of the display assembly 100 does not protrude from the first plate body 210 in the height direction. The part of the optical assembly 440 may be located in the accommodation space 343, which may increase the first plate body 210 in the limited space inside the housing 400, thereby providing sufficient installation position for the storage chip 211, and avoiding the size of the near-eye display module 01 from being too large in the height direction.

In storage assembly 200, the second plate body 220 is connected to the first plate body 210. The first plate body 210 is configured to be non-parallel to the second plate body 220 after folding the fifth fold section 212. The storage assembly 200 is folded, so as to form a folded storage assembly 200; the display module 100 is folded, so as to form a folded display module 100; and the shape of the folded storage assembly 200 is different from the shape of the display module 100. The storage assembly 200 may be foldable, for example, the storage assembly 200 is folded into a shape that is looked like the L-shaped from the side view. Alternatively, the first plate body 210 may be unfolded relative to the second plate body 220, so that the first plate body 210 and the second plate body 220 are coplanar or approximately coplanar. The display module 100 may be foldable, for example, the display module 100 is folded into the shape that is looked like the U-shape from the side view. Alternatively, after the display module 100 is folded, the first base 110 is parallel or approximately parallel to the second base 120. The storage chip 211 may include a random access memory (RAM) or a read-only memory (ROM), such as a flash memory, an electrically erasable programmable read-only memory (EEPROM). The storage chip 211 may store driver programs or image data that may be displayed on the micro-display 111, such as control programs configured for driving the micro-display 111 to emit light, base images of certain image frameworks, or the like, so as to enable the micro-display 111 to achieve expected image display in a short period of time. In some embodiments, the main control plate may be provided with relevant light sensors or human-machine interaction sensors (such as inertia sensors, etc.), which may store some preset sensing data in advance. In some embodiments, the storage chip 211 may also store certain basic data packets or communication data packets for subsequent firmware upgrades, which may be retrieved by the main control unit to improve operation efficiency.

The adapter plate 320 is configured to at least partially overlap with the main control plate 310 in the first direction after folding the first fold section 321. The first direction of the present disclosure may be an axial direction of the housing 400. The size of the adapter plate 320 may be smaller than that of the main control plate 310. The adapter plate 320 moves or is flipped or is folded relative to the main control plate 310 by folding the first fold section 321, so that the adapter plate 320, the first fold section 321, and the main control plate 310 form a shape that is looked like the U-shaped from the side view. In some embodiments, after folding the first fold section 321, the adapter plate 320 may be fully projected onto the main control plate 310 in the first direction. Alternatively, after folding the first fold section 321, some parts of the adapter plate 320 are staggered with the main control plate 310, so that only a part of the adapter plate 320 is projected onto the main control plate 310 in the first direction. In some embodiments, the adapter plate 320 may be parallel or approximately parallel to the main control plate 310 after folding the first fold section 321. In some embodiments, the adapter plate 320 may move or be flipped or be unfolded relative to the main control plate 310 by unfolding the first fold section 321, so that the adapter plate 320 and the main control plate 310 are coplanar or approximately coplanar. In some embodiments, the adapter plate 320 may also be maintained in the folded state relative to the main control plate 310 by an external housing, a clip, an adhesive, or by curing insulating glue or epoxy resin. The relevant folding referred to in the present disclosure may be maintained in the folded state after assembly is completed.

The second base 120 is configured to at least partially overlap with the first base 110 in the first direction after folding the fourth fold section 113. The areas of the second base 120 and the first base 110 may be the same or approximately the same. After the second base 120 moves or is flipped or is folded relative to the first base 110 by folding the fourth fold section 113, the second base 120 may be fully projected onto the first base 110 in the first direction. Alternatively, after folding the fourth fold section 113, the second base 120 and the first base 110 are partially staggered, causing the second base 120 and the first base 110 to be partially projected in the first direction. In some embodiments, the second base 120 and the first base 110 may be parallel or approximately parallel to each other after folding the fourth fold section 113. The second base 120 may move or be flipped or be folded relative to the first base 110 by folding the fourth fold section 113, so that the second base 120, the fourth fold section 113, and the first base 110 form the shape that is looked like the U-shape from the side view. The folded structure formed by moving or flipping or folding or unfolding the first base 110 relative to the second base 120 through folding or unfolding the fourth fold section 113 may be the same as or similar to the folded structure formed by moving or flipping or folding or unfolding the adapter plate 320 relative to the main control plate 310 through folding or unfolding the first fold section 321. In some embodiments, the second base 120 may move or be flipped or be unfolded relative to the first base 110 by unfolding the fourth fold section 113, so that the second base 120 and the first base 110 are coplanar or approximately coplanar. In some embodiments, the second base 120 may also remain in the folded state relative to the first base 110. The second plate body 220 is configured to be located between the main control plate 310 and the second base 120, and the storage chip 211 is electrically connected to the micro-display 111. The second plate body 220 may be connected between the main control plate 310 and the second base 120 by using a method, such as electrical plugging or soldering. The first base 110 and the second base 120 are configured to clamp the adapter plate 320 and electrically connect the micro-display 111 to the main control plate 310. The adapter plate 320 may be connected to the first base 110 by using the method, such as electrical plugging or soldering. The light-emitting surface 114 of the micro-display 111 is opposite to or away from the adapter plate 320 in the first direction.

During assembling the above assemblies, the second base 120 is first connected to the adapter plate 320, then the adapter plate 320 moves or is flipped or is folded by folding the first fold section 321, so that the adapter plate 320 and the main control plate 310 overlap with each other and the first surface of the adapter plate 320 faces the main control plate 310. The first base 110 moves or is flipped or is folded relative to the second base 120 by folding the fourth fold section 113, so as to ensure that the light-emitting surface 114 of the micro-display 111 faces upward. And then, the second plate body 220 is inserted and in contact with the surface of the second base 120 opposite to or away from the adapter plate 320. After the above assemblies or components are assembled, in the first direction and along the light-emitting direction of the micro-display 111, the main control plate 310, the second plate body 220, the second base 120, the adapter plate 320, the first base 110, and the micro-display 111 are stacked in sequence. Since the control plate assembly 300, the display assembly 100, and the storage assembly 200 may be independently designed and manufactured, compared with the whole circuit plate with a larger area, the cost is lower.

In some embodiments, for simple function near-eye display modules, generally, the storage assembly 200 and the control plate assembly 300 are disposed on the same circuit plate, then folding and assembling are performed. However, as the functions increase, the thickness and the width of the storage chip 211 of the storage assembly 200 also need to be correspondingly increased. If simply folded, it may cause the height of the near-eye display module to be too large. Combined with the usage scenario of the near-eye display in the present disclosure. In response to the near-eye display module being directly facing the human eye, the larger thickness of the near-eye display module may easily cause a sense of being poked by foreign objects in the eyes. That is, in response to the near-eye display module being too thick or too close to the eyes, the human body may feel uncomfortable. In the present disclosure, the first plate body 210 with the larger thickness of the storage assembly 200 moves or is flipped or is folded to a side surface of the main control plate 310 by folding the fifth fold section 212, which effectively reduces the thickness caused by the storage assembly 200. In addition, the folded structure formed by moving or flipping or folding or unfolding the adapter plate 320 of the control plate assembly 300 relative to the main control plate 310 through folding or unfolding the first fold section 321 is similar to the folded structure formed by moving or flipping or folding or unfolding the first base 110 relative to the second base 120 of the display assembly 100 through folding or unfolding the fourth fold section 113. The folded structure formed by moving or flipping or folding or unfolding the first plate body 210 relative to the second plate body 220 of the storage assembly 200 through folding or unfolding the fifth fold section 212 is different from the folded structure formed by moving or flipping or folding or unfolding the first base 110 relative to the second base 120 of the display assembly 100 through folding or unfolding the fourth fold section 113. Thus, each structure may be fully utilized in the space, and the space generated by folding different components may be configured to accommodate other components with other structures. Some electronic elements are disposed in different directions from the arrangement direction of the control plate assembly 300, the storage assembly 200, and the display assembly 100, which effectively avoiding the excessive size of the near-eye display module 01 in the single direction caused by the excessive sizes of the control plate assembly 300, the storage assembly 200, and the display assembly 100 in the single direction after these three assemblies are connected. It ensures that the size and the volume of the entire assembled component minimize.

In some embodiments, the first fold section 321 can be a part of the adapter plate 320. When the first fold section 321 is the part of the adapter plate 320, the adapter plate 320 is foldable, in this case, folding or unfolding the first fold section 321 is folding or unfolding the adapter plate 320. In some embodiments, the first fold section 321 can have a shorter length.

In some embodiments, the second fold section 331 can be a part of the antenna plate 330. When the second fold section 331 is the part of the antenna plate 330, the antenna plate 330 is foldable, in this case, folding or unfolding the second fold section 331 is folding or unfolding the antenna plate 330. In some embodiments, the second fold section 331 can have a shorter length.

In some embodiments, the third fold section 340 can be a part of first power plate 341 or a part of the second power plate 342. When the third fold section 340 is the part of first power plate 341, the first power plate 341 is foldable, in this case, folding or unfolding the third fold section 340 is folding or unfolding the first power plate 341. When the third fold section 340 is the part of the second power plate 342, the second power plate 342 is foldable, in this case, folding or unfolding the third fold section 340 is folding or unfolding the second power plate 342. In some embodiments, the third fold section 340 can have a shorter length.

In some embodiments, the fourth fold section 113 can be a part of the first base 110 or a part of the second base 120. When the fourth fold section 113 is the part of the first base 110, the first base 110 is foldable, in this case, folding or unfolding the fourth fold section 113 is folding or unfolding the first base 110. When the fourth fold section 113 is the part of the second base 120, the second base 120 is foldable, in this case, folding or unfolding the fourth fold section 113 is folding or unfolding the second base 120. In some embodiments, the fourth fold section 113 can have a shorter length.

In some embodiments, the fifth fold section 212 can be a part of the first plate body 210 or a part of the second plate body 220. When the fifth fold section 212 is the part of the first plate body 210, the first plate body 210 is foldable, in this case, folding or unfolding the fifth fold section 212 is folding or unfolding the first plate body 210. When the fifth fold section 212 is the part of the second plate body 220, the second plate body 220 is foldable, in this case, folding or unfolding the fifth fold section 212 is folding or unfolding the second plate body 220. In some embodiments, the fifth fold section 212 can have a shorter length.

In some embodiments, as illustrated in FIGS. 1-15, the first power plate 341 and the second power plate 342 are provided with power supply circuits, such as boost and buck circuits, voltage stabilization circuits, driving circuits, or the like. The above circuits may further include corresponding microprocessor chips, resistors, capacitors, inductors, switch tubes, amplifiers, or the like. The first power plate 341 and the second power plate 342 are spaced apart from each other, and electrically connected to the main control plate 310. Each of the first power plate 341 and the second power plate 342 is configured to be non-parallel to the main control plate 310 after folding the third fold section 340, and the first power plate 341 and the second power plate 342 are located on different planes. The first power plate 341, the second power plate 342, and the main control plate 310 forms the accommodation space 343. The first power plate 341, the main control plate 310, and the second power plate 342 jointly enclose to form the accommodation space 343. As illustrated in FIG. 15, the display assembly 100 and the storage assembly 200 are located in the accommodation space 343, and the height of the micro-display 111 is less than that of the accommodation space 343. The micro-display 111 does not protrude from the accommodation space 343. That is, after folding and assembling, the height of the micro-display 111 is less than the height of the first power plate 341 and the height of the second power plate 342. The light of the micro-display 111 is emitted through the accommodation space 343, thereby fully utilizing the internal space of the housing 400 and reducing the height of the micro-display 111, the first power plate 341, and the second power plate 342.

In some embodiments, as illustrated in FIGS. 1-15, the antenna plate 330 is connected to the side edge of the main control plate 310 and is spaced apart from the first power plate 341 and the second power plate 342. The antenna plate 330 is configured to be non-parallel to the main control plate 310 after folding the second fold section 331, and the plane of the antenna plate 330 is different from the plane of the first power plate 341 and the plane of the second power plate 342. The antenna plate 330 is electrically connected to the main control plate 310, and the height of the micro-display 111 is less than that of the antenna plate 330. The antenna plate 330, the first power plate 341, the second power plate 342, and the main control plate 310 jointly enclose to form the accommodation space 343. The first power plate 341 and the second power plate 342 may be disposed opposite or adjacent to each other. The antenna plate 330 may be disposed adjacent to the first power plate 341, or the antenna plate 330 may be disposed adjacent to the second power plate 342. The antenna plate 330 is provided with the antenna 3301 that is configured to communicate with the external device. The external device may be the smartphone, the computer, the tablet, the smart glasses, the watch, or the like. The near-eye display module 01 receives the image content from the external device for display.

In some embodiments, the near-eye display module 01 further includes the battery 442. The battery 442 may be a rechargeable battery or a disposable battery. The battery 442 may be a button battery, a circular battery, or the like. The battery 442 is electrically connected to the main control plate 310, the first power plate 341, and the second power plate 342, so as to supply power to all electronic elements. The battery 442 is located on the side of the main control plate 310 opposite to or away from the second plate body 220, and the battery 442 is parallel or approximately parallel to the main control plate 310, which may avoid excessive radial size caused by combining the battery 442 with the power plate, thereby fully utilizing the space of the housing 401 and ensuring the miniaturization of the near-eye display module 01.

In some embodiments, as illustrated in FIGS. 1-15, the near-eye display module 01 further includes the first fold section 321, the second fold section 331, the third fold section 340, the fourth fold section 113, and the fifth fold section 212. The first fold section 321, the second fold section 331, the third fold section 340, the fourth fold section 113, and the fifth fold section 212 may be foldable or unfoldable. The above fold sections may be formed by two electrical plates hinged to each other, flexible wires, or flexible printed circuit plates. As illustrated in FIGS. 10-15, the adapter plate 320 is connected to the main control plate 310 through the first fold section 321, the antenna plate 330 is connected to the main control plate 310 through the second fold section 331, and the first power plate 341 and the second power plate 342 are respectively connected to the main control plate 310 through the third fold section 340. The antenna plate 330, the first power plate 341, the adapter plate 320, and the second power plate 342 are distributed at intervals along the circumferential direction of the main control plate 310, so as to effectively avoid interference between the adapter plate 320, the first power plate 341, the second power plate 342, and the antenna plate 330 in the folded state. As illustrated in FIGS. 10-12, after the second fold section 331, the third fold section 340, and the first fold section 321 are unfolded, the antenna plate 330, the first power plate 341, the adapter plate 320, the second power plate 342, and the main control plate 310 are coplanar or approximately coplanar. The electronic elements on the antenna plate 330 may also be located on the side surface of the antenna plate 330 facing the accommodation space 343, so as to protect the electronic elements.

The first base 110 is connected to the second base 120 through the fourth fold section 113, and the first base 110 and the second base 120 may be the plate-shaped. As illustrated in FIG. 6, the second base 120 is also configured to be coplanar or approximately coplanar with the first base 110, and the first base 110, the fourth fold section 113, and the second base 120 may be in the straight line. The first base 110 and the second base 120 may be movable relative to each other, allowing the display assembly 100 to be folded or unfolded, thereby facilitating assembly. As illustrated in FIG. 6, in a third folded state, the first base 110, the fourth fold section 113, and the second base 120 are connected in sequence and on the same straight line, so that the display assembly 100 is the flat-plate-shaped. In this case, the first base 110 and the second base 120 are separated and spaced apart from each other, and the display assembly 100 is unfolded, making it easier for the micro-display 111, the fourth connection bit 121, and the second connection bit 122 to be installed on the first base 110 or the second base 120. The width of the fourth fold section 113 is less than that of the first base 110 and less than that of the second base 120, so as to reduce the space occupied by the fourth fold section 113 and facilitate storage.

As illustrated in FIGS. 7 and 14, in some embodiments of the present disclosure, the thickness of the first base 110 is defined as L1, and the thickness of the second base 120 is defined as L2. The length of the fourth fold section 113 is greater than L1+L1, so that in the third unfolded state, the first base 110 and the second base 120 may be separated and spaced apart from each other, and there is a connection space between the first base 110 and the second base 120. The connection space may accommodate other elements connected to the display assembly 100. In this case, the fourth connection bit 121 or the second connection bit 122 may be disposed on the side surface of the second base 120 facing the first base 110, so as to directly connect with the external element, thereby reducing the number of connecting elements and saving space.

In some embodiments, the first fold section 321, the second fold section 331, the third fold section 340, the fourth fold section 113, and the fifth fold section 212 may be flat-shaped. In order to electrically connect different elements, the first fold section 321, the second fold section 331, the third fold section 340, the fourth fold section 113, and the fifth fold section 212 may be provided with conductive wires with different quantities and types. The first fold section 321, the second fold section 331, the third fold section 340, the fourth fold section 113, and the fifth fold section 212 have different widths. The width of the first fold section 321 is greater than that of the second fold section 331, and the width of the third fold section 340 is greater than that of the first fold section 321. The width of the fifth fold section 212 is greater than or equal to that of the fourth fold section 113.

In the display assembly 100 of the present disclosure, the micro-display 111, the fourth connection bit 121, and the second connection bit 122 are separated through the first base 110 and the second base 120. In the third folded state, the display assembly 100 is unfolded, so as to facilitate soldering and installation of the micro-display 111, the fourth connection bit 121, and the second connection bit 122 during the manufacturing process. Moreover, the display assembly 100 may be switched to the third unfolded state through the fourth fold section 113. The fourth fold section 113 is folded, so that the first base 110 and the second base 120 are stacked on each other. The micro-display 111, the fourth connection bit 121, and the second connection bit 122 are separated, which facilitates assembly and breaks the limitations of the single base structure, thereby increasing space utilization, making space arrangement more flexible, and avoiding assembly inconvenience caused by excessive size of the display assembly 100 in the single direction.

The second plate body 220 is connected to the first plate body 210 through the fifth fold section 212, as illustrated in FIG. 8. The first plate body 210 is also configured to be coplanar or approximately coplanar with the second plate body 220 after unfolding the fifth fold section 212. In this case, the second plate body 220, the fifth fold section 212, and the first plate body 210 may be in the straight line.

The first fold section 321, the second fold section 331, the third fold section 340, the fourth fold section 113, and the fifth fold section 212 include the flexible circuit plate. The flexible circuit plate may be a substate made of a polyimide (PI) material, and a conductive layer formed by metal (such as copper) etching is disposed on the substate. In some embodiments, an insulating layer may also be disposed on the surface of the conductive layer opposite to or away from the substrate, so as to prevent short circuit and enhance the stability of the circuit. Alternatively, a protective layer, such as a coating agent or an anti-oxidation layer, may be disposed on the surface of the conductive layer opposite to or away from the substrate, so as to facilitate the folding of the fold section and prevent damage.

In some embodiments, each of the main control plate 310, the antenna plate 330, the first power plate 341, the adapter plate 320, and the second power plate 342 includes the first surface and the second surface. The first surface and the second surface are two opposite surfaces, or two surfaces of the same plate corresponding to the front and back. In some embodiments, FIG. 10 shows the first surface, also known as a front surface, while FIG. 11 shows the second surface, also known as a back surface.

The first surface of the adapter plate 320 is provided with the first connection bit 322, and the second surface of the adapter plate 320 is free of any element. The first surface of the adapter plate 320 is configured to face the first surface of the main control plate 310 after folding the first fold section 321. The first connection bit 322 is disposed on the adapter plate 320 that may be movable relative to the main control plate 310 and is stacked with the display assembly 100, the adapter plate 320 is located in the accommodation space 343, so as to reduce the distance between the first connection bit 322 and the second connection bit 122, thereby facilitates connection. By flexibly changing the position of the adapter plate 320 through the first fold section 321, on the one hand, it may avoid the overall device from being too large in a single direction, and on the other hand, the compatibility of the control plate assembly 300 with the installation environment is better. In addition, during soldering the electronic element, due to the separation of the first connection bit 322 and the main control plate 310, the operating space is larger in the process of soldering, which is easier to solder. The first connection bit 322 may include a soldering point or an electrical socket. Alternatively, the first connection bit 322 may include the soldering point and the electrical socket.

The first surface of the main control plate 310 is provided with the main control unit 3111 and the main control sub-elements 3112. The main control unit 3111 and the main control sub-elements 3112 are electrically connected to each other. The main control unit 3111 may include a chip with processing function, and the main control sub-elements 3112 include the resistors, the capacitors, the inductors, the switch tubes, or the amplifiers. The second surface of the main control plate 310 is provided with the power connection bit 311, and the power connection bit 311 is electrically connected to the battery 442. The power connection bit 311 may include the positive connection point and the negative connection point. In some embodiments, both the positive connection point and the negative connection point are disposed on the same surface of the battery 442. The power connection bit 311 includes corresponding positive connection point and negative connection point, the battery 442 is in contact with the power connection bit 311, so as to achieve electrical connection. In some embodiments, the power connection point 311 includes a central polarity connection point and multiple peripheral electrical connection points, and the multiple peripheral electrical connection points are disposed around the central polarity connection point. The central polarity connection point may be one of the positive electrode and the negative electrode, and the peripheral electrical connection point may be the other of the positive electrode and the negative electrode.

The antenna 3301 is located on the first surface or the second surface of the antenna plate 330. The first surface of the antenna plate 330 is configured to form the angle with the first surface of the main control plate 310 after folding the second fold section 331. In some embodiments, the first surface of the antenna plate 330 is perpendicular to the first surface of the main control plate 310, that is, the angle is 90 degrees. Alternatively, the angle is less than 90 degrees. The antenna 3301 may be formed by printing, etching, injection molding, or sintering. Alternatively, the antenna 3301 may be electrically connected to the antenna plate 330 by soldering or other methods. The antenna plate 330 is connected to the main control plate 310 through the second fold section 331. The second fold section 331 is configured to be foldable, so as to change the relative position between the antenna plate 330 and the main control plate 310. The power plate is connected to the main control plate 310 through the third fold section 340. The third fold section 340 is configured to be foldable, so as to change the relative position between the power plate and the main control plate 310. The power plate may adjust the current and the voltage output from the power supply, so as to provide the current and the voltage to electronic elements on the control plate assembly 300.

As illustrated in FIGS. 11 and 12, FIGS. 11 and 12 are schematic views from the same view. The second fold section 331 is connected to a side edge of the main control plate 310. The width of the second fold section 331 is less than the length of the side edge of the main control plate 310 that is connected to the second fold section 331, so as to form the avoidance gap 344 between the main control plate 310 and the antenna plate 330. Thus, as illustrated in FIG. 12, after folding the second fold section 331, there is still the avoidance gap 344 between the antenna plate 330 and the main control plate 310, so that the external element passes though the avoidance gap 344, thereby avoiding interference between the antenna plate 330 and the display assembly 100.

As illustrated in FIGS. 12 and 13, in some embodiments of the present disclosure, the main control plate 310 has the first side edge and the second side edge opposite to each other. The first fold section 321 is connected to the first side edge of the main control plate 310, and the second fold section 331 is connected to the second side edge of the main control plate 310. The width of the second fold section 331 is less than the length of the second side edge of the main control plate 310. In the second state, the adapter plate 320 is opposite to the antenna plate 330, that is, the avoidance gap 344 is opposite to the first side edge where the adapter plate 320 is located. Thus, a part of the display assembly 100 may pass through the avoidance gap 344, so as to avoid interference between the display assembly 100 and the antenna plate 330.

The first connection bit 322 is electrically connected to the main control unit 3111 and the main control sub-elements 3112 on the main control plate 310 through the first fold section 321. The antenna 3301 is electrically connected to the main control unit 3111 and the main control sub-elements 3112 on the main control plate 310 through the second fold section 331. The power sub-elements 3411, 3421 are electrically connected to the main control unit 3111 and the main control sub-elements 3112 on the main control plate 310 through the third fold section 340.

The control plate assembly 300 may be in the first state and the second state. By unfolding or folding the first fold section 321, the second fold section 331, and the third fold section 340, the relative position between the main control plate 310 and the adapter plate 320, the relative position between the main control plate 310 and the antenna plate 330, and the relative position between the main control plate 310 and the power plate may be changed, so as to switch the control plate assembly 300 between the first state and second state. As illustrated in FIGS. 10 and 11, in the first state, the first fold section 321, the second fold section 331, and the third fold section 340 are all unfolded, that is the entire control plate assembly 300 is unfolded. The adapter plate 320, the power plate, the antenna plate 330, and the main control plate 310 are all on the same plane, which facilitates the installation of the electronic elements on the main control plate 310, the adapter plate 320, the power plate, and the antenna plate 330.

As illustrated in FIG. 13, in the second state, the first fold section 321, the second fold section 331, and the third fold section 340 are all folded, that is the entire the control plate assembly 300 is folded. The adapter plate 320, the power plate, and the antenna plate 330 are all located on a side of the main control plate 310. The main control plate 310 and at least one of the adapter plate 320, the power plate, and the antenna plate 330 forms the angle greater than 0 degrees, so as to form the accommodation space 343. Thus, the control plate assembly 300 is switched to be in the second state, so that the structure with the three-dimensional space is formed, thereby reducing the size of the control plate assembly 300 on the plane where the main control plate 310 is located. The main control plate 310 and at least one of the adapter plate 320, the power plate, and the antenna plate 330 forms the angle greater than 0 degrees, thereby forming the accommodation space 343 configured for accommodating the display assembly 100 and the storage assembly 200, which avoids the adapter plate 320, the power plate, and the antenna plate 330 from being stacked on each other in the thickness direction of the main control plate 310. Stacking the adapter plate 320, the power plate, and the antenna plate 330 on each other in the thickness direction of the main control plate 310 may cause the overall thickness of the control plate assembly 300 to be too large after connecting the display assembly 100 and the storage assembly 200 to the control plate assembly 300. Thus, forming the accommodation space 343 may avoid the overall thickness of the control plate assembly 300 from being too large after connecting the display assembly 100 and the storage assembly 200 to the control plate assembly 300. After folding the fold sections, the adapter plate 320, the power plate, and the antenna plate 330 are all located on the same side of the main control plate 310, which means that after folding the fold sections, the adapter plate 320, the power plate, the antenna plate 330, and the main control plate 310 are not on the same plane. The angle between the main control plate 310 and each of the adapter plate 320, the power plate, the antenna plate 330 is less than 180 degrees. The above method may effectively avoid the adapter plate 320, the power plate, and the antenna plate 330 from being stacked on each other in the thickness direction of the main control plate 310, and avoids the overall thickness of the control plate assembly 300 from being too large after the display assembly 100 and the storage assembly 200 are connected to the control plate assembly 300, thereby optimizing the spatial layout.

In some embodiments, each of the first base 110 and the second base 120 includes the first surface and the second surface, and the first surface is opposite to the second surface. The first surface of the first base 110 is provided with the micro-display 111, and the second surface of the first base 110 is provided with the first reinforcement sheet 112. The first surface of the second base 120 is provided with the fourth connection bit 121, and the second surface of the second base 120 is provided with the second connection bit 122. The micro-display 111 is electrically connected to the fourth connection bit 121 and the second connection bit 122 through the fourth fold section 113. The first connection bit 322 is configured to be electrically connected to the second connection bit 122, and the second surface of the second base 120 is configured to be opposite to the second surface of the first base 110 after folding the fourth fold section 113. That is, corresponding connection bits are respectively disposed on two opposite surfaces of the second base 120, thereby ensuring that the micro-display 111 is respectively electrically connected to the main control plate 310 and the storage chip 211.

The first reinforcement sheet 112 is disposed on the side surface of the first base 110 opposite to or away from the micro-display 111, so as to support and protect the micro-display 111. As illustrated in FIG. 6, the first reinforcement sheet 112 is the plate-shaped. The area of the side surface of the first reinforcement sheet 112 facing the micro-display 111 is greater than that of the side surface of the micro-display 111, so that the orthographic projection of the micro-display 111 on the plane of the first reinforcement sheet 112 is located on the first reinforcement sheet 112. In some embodiments, the first reinforcement sheet 112 may be adhered to the first base 110. In some embodiments, the first reinforcement sheet 112 and the first base 110 may be integrated.

In some embodiments, each of the second plate body 220 and the first plate body 210 includes the first surface and the second surface. The first surface is opposite to the second surface. The first surface of the first plate body 210 is configured to form the angle with the first surface of the second plate body 220 after folding the fifth fold section 212. The angle is 90 degrees or less than 90 degrees. The first surface of the second plate body 220 is provided with the third connection bit 221, and the storage chip 211 is located on the first surface or the second surface. The third connection bit 221 is electrically connected to the storage chip 211 through the fifth fold section 212. The storage assembly 200 may be switched between the unfolded state and the folded state. The third connection bit 221 is configured to be electrically connected to the fourth connection bit 121, so that the storage chip 211 is electrically connected to the micro-display 111 though the second plate body 220. The third connection bit 221 is disposed on the side surface of the second plate body 220 facing the included angle space, which may reduce the distance between the third connection bit 221 and the fourth connection bit 121, thereby facilitating connection.

In the unfolded state, the first plate body 210 and the second plate body 220 are on the same plane. The first plate body 210 and the second plate body 220 are separated, so as to facilitate the soldering of the storage chip 211 and the third connection bit 221 on the first plate body 210 or the second plate body 220. As illustrated in FIG. 8, in some embodiments, the first plate body 210, the fifth fold section 212, and the second plate body 220 are sequentially connected. In the unfolded state, the first plate body 210, the fifth fold section 212, and the second plate body 220 are in the same straight line, and the storage assembly 200 is the flat-plate-shaped. The storage assembly 200 is switched to the folded state, and the first plate body 210 is flipped relative to the second plate body 220 by a certain angle. As illustrated in FIG. 9, in the folded state, the fifth fold section 212 is folded, thereby forming an angle between the first plate body 210 and the second plate body 220. The storage chip 211 and the third connection bit 221 are located on different planes, so as to fully utilize space and avoid the size of the storage assembly 200 from being too large in the single direction. The first plate body 210 and the second plate body 220 define the accommodation space 343 that is configured for accommodating the display assembly 100. The storage angle defined as A is formed between the first plate body 210 and the second plate body 220, wherein 0°<A<180°, such as, 80 degrees, 90 degrees, 100 degrees, or the like. As illustrated in FIG. 9, the storage angle A is 90 degrees. Thus, the storage assembly 200 is connected to the display assembly 100, and the display assembly 100 may be disposed in the accommodation space 343 and in direct contact with the second plate body 220, which shortens a connection distance between the display assembly 100 and the third connection bit 221. The display assembly 100 may be directly connected to the third connection bit 221, thereby simplifying the connection wire.

In some embodiments of the present disclosure, in the unfolded state, the storage assembly 200 includes two opposite surfaces, the storage chip 211 is located on one of the two opposite surfaces of the storage assembly 200, and the third connection bit 221 is located on the other of the two opposite surfaces of the storage assembly 200. As illustrated in FIG. 8, the storage chip 211 is located on the surface of the first plate body 210 facing upward (i.e., the direction as illustrated in FIG. 8), and the third connection bit 221 is located on the surface of the second plate body 220 facing downward. The storage chip 211 and the third connection bit 221 are located on different surface. After folding the fifth fold section 212, one of the storage chip 211 and the third connection bit 221 is located inside the accommodation space 343, and the other of the storage chip 211 and the third connection bit 221 is located outside the accommodation space 343. It may avoid interference between the storage chip 211, the third connection bit 221, and the display assembly 100 in the accommodation space 343 caused by both the storage chip 211 and the third connection bit 221 are disposed in the accommodation space 343. As illustrated in FIG. 9, in some embodiments, in the folded state, the storage chip 211 is located on the side surface of the first plate body 210 opposite to or away from the accommodation space 343, which avoids interference between the storage chip 211 and the display assembly 100 in the accommodation space 343. The third connection bit 221 is located in the accommodation space 343, which shortens the distance between the third connection bit 221 and the display assembly 100 in the accommodation space 343, and facilitates connection. The third connection bit 221 may be directly connected to the display assembly 100.

In some embodiments, the storage chip 211 and the third connection bit 221 may be located on the same side. In some embodiments, the storage chip 211 is located on the surface of the first plate body 210 facing downward, and the third connection bit 221 is located on the surface of the second plate body 220 facing upward. The fifth fold section 212 is switched to the folded state, according to the folding direction, the storage chip 211 and the third connection bit 221 may be simultaneously located inside or outside the accommodation space 343, which may depend on the installation environment of the storage assembly 200.

In some embodiments of the present disclosure, the second reinforcement sheet is disposed on the second plate body 220, and the second reinforcement sheet may be the plate-shaped. The second plate body 220 includes two opposite side surfaces, the third connection bit 221 is located on one of the two opposite side surfaces, and the second reinforcement sheet is located on the other of the two opposite side surfaces. The second reinforcement sheet may support and protect the third connection bit 221, and the second reinforcement sheet may be adhered to the second plate body 220. The area of the side surface of the second reinforcement sheet connected to the second plate body 220 is greater than or equal to the area of the side surface of the second plate body 220 where the third connection bit 221 is located. In some embodiments, the second reinforcement sheet and the second plate body 220 are integrated.

The second plate body 220 and the first plate body 210 are located on different planes and are not parallel to each other. The second plate body 220 and the first plate body 210 define the included angle space. In this case, the thickness direction of the second plate body 220 is different from the thickness direction of the first plate body 210, which may avoid the excessive thickness of the storage assembly 200. The display assembly 100 is located in the included angle space. The display assembly 100 is connected to the control plate assembly 300 and the storage assembly 200. By setting the control plate assembly 300 and the storage assembly 200 as the structures connected by multiple plates, the control plate assembly 300 and the storage assembly 200 may be folded to form the three-dimensional space. The installation space may be fully utilized, avoiding the sizes of the control plate assembly 300 and the storage assembly 200 from being too large in the single direction. The storage assembly 200 is located in the accommodation space 343 of the control plate assembly 300, and the display assembly 100 is located in the included angle space of the storage assembly 200. The structure is compact and a relatively enclosed installation environment is formed, which plays a role in protecting and preventing dust.

The first connection bit 322, the second connection bit 122, the third connection bit 221, and the fourth connection bit 121 may be electrical contact points, solder points, electrical sockets or plugs that cooperate with each other, such as electrical male socket and female socket that cooperate with each other.

In some embodiments, the area of the adapter plate 320 and the area of the antenna plate 330 are respectively smaller than that of the second power plate 342. That is, there is no redundant electrical element on the adapter plate 320. The area of the main control plate 310 and the area of the first power plate 341 are respectively greater than that of the second power plate 342. The first plate body 210 is located between the first power plate 341 and the second power plate 342, and the height of the micro-display 111 is less than that of the first plate body 210. The first power plate 341 is also configured to be parallel or approximately parallel to the second power plate 342 after folding the third fold section 340. Thai is, in the folded state, the first power plate 341, the first plate body 210, and the second power plate 342 may be parallel or approximately parallel to each other. The first plate body 210 may be located between the first power plate 341 and the second power plate 342, and the storage chip 211 may face the first power plate 341 or the second power plate 342. As illustrated in FIGS. 10 and 11, in some embodiments of the present disclosure, the adapter plate 320 is connected to the main control plate 310 through the first fold section 321, the antenna plate 330 is connected to the main control plate 310 through the second fold section 331, and the power plate is connected to the main control plate 310 through the third fold section 340. In the first folded state, the first fold section 321, the second fold section 331, and the third fold section 340 are all folded; the adapter plate 320, the power plate, and the antenna plate 330 are all located on a side of the main control plate 310; and the main control plate 310 and at least one of the adapter plate 320, the power plate, and the antenna plate 330 form the angle greater than 0 degrees, so that the accommodation space 343 is defined.

In some embodiments, the near-eye display module 01 further includes the optical assembly 440 located in the accommodation space 343. The optical assembly 440 at least partially overlaps with the first power plate 341 and the second power plate 342 in the second direction. The second direction is perpendicular to the first direction. At least a part of the optical assembly 440 is accommodated in the accommodation space 343 in the first direction (which may also be the axial direction or the optical axis direction). In some embodiments, the housing 400 is provided with the light-transmitting part 411. The light-transmitting part 411 may be a solid light-transmitting area of the housing 400. Alternatively, the light-transmitting part 411 is a through-hole defined in the housing 400. The light of the optical assembly 440 is emitted through the through-hole. An additional light-transmitting protective cover may be disposed on the through-hole to protect the optical assembly 440. The optical assembly 440 is located between the display assembly 100 and the light-transmitting part 411. The optical axis of the micro-display 111, the optical axis of the optical assembly 440, and the central axis of the light-transmitting part 411 are on the same straight line (optical axis). As illustrated in FIGS. 1 and 4, a dashed line with an arrow as illustrated in FIG. 4 represents the optical axis of the display assembly 100. As illustrated in FIGS. 4 and 5, in some embodiments, the top of the display assembly 100 is lower than the top of the accommodation space 343, and an end of the optical assembly 440 facing the display assembly 100 is located in the accommodation space 343, which may increase a height of a peripheral wall of the accommodation space 343 in the limited space. That is, the heights of the first power plate 341 and the second power plate 342 increase, and accordingly the area of the control plate assembly 300 increase, so as to allow more electronic elements to be installed. Furthermore, the internal structure of the near-eye display module 01 is more compact. In some embodiments, the optical assembly 440 may be implemented by using the solution of Chinese application number 2023224964840.

In some embodiments, the housing 400 includes the cover body 410. A fixed step is disposed on a position of the light-transmitting part 411 corresponding to the cover body 410. A fixed block 441 is disposed on the side surface of the optical assembly 440. The fixed block 441 is in direct contact with the fixed step. A gap is between the micro-display 111 and the optical assembly 440 in the first direction. As illustrated in FIGS. 1 and 4, a position of the light-transmitting part 411 is located in a non-central area of the cover body 410, and the central axis of the optical assembly 440 is spaced apart from the central axis of the main control plate 310. As illustrated in FIG. 7, after the second base 120 is configured to at least partially overlap with the first base 110 after folding the fourth fold section 113 in the first direction, the light-emitting surface 114 of the micro-display 111 deviates from a center position of the display assembly 100. The position of the light-transmitting part 411 is located in the non-central area of the cover body 410, and the central axis of the optical assembly 440 is spaced apart from the central axis of the main control plate 310, so that the light-transmitting part 411 corresponds to the light-emitting surface 114 of the micro-display 111. Thus, the light output from the near-eye display module 01 deviates from the central axis of the near-eye display module 01 and are in the optimal field of view range during installing the near-eye display module 01 on the frame or lens. In some embodiments, the positions of the micro-display 111, the transparent portion 411, and the optical assembly 440 may allow the light output from the near-eye display module 01 to be concentrated near the central axis.

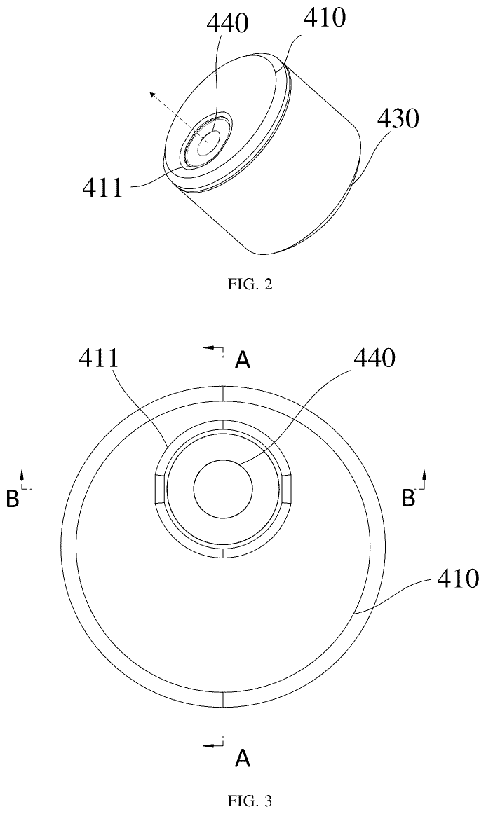

As illustrated in FIG. 1 and FIG. 2, the housing 400 includes the cover body 410, a middle housing 420, and a base body 430 connected in sequence. The cover body 410, the middle housing 420, and the base body 430 jointly define the installation space 401. As illustrated in FIGS. 2 and 3, the light-transmitting part 411 is disposed on the cover body 410, and the optical assembly 440 is connected to the cover body 410. The side surface of the cover body 410 facing the installation space 401 may be provided with a plug-in plate 412. The plug-in plate 412 extends along the thickness direction of the cover body 410 and is disposed around the light-transmitting part 411.

In some embodiments, the optical assembly 440 is provided with a first fixing part, and the plug-in plate 412 is provided with a second fixing part. The first fixing part is connected to the second fixing part, so as to fix the optical assembly 440. One of the first fixed part and the second fixed part may be a protrusion, and the other of the first fixed part and the second fixed part may be a groove. In some embodiments, as illustrated in FIG. 1, the optical assembly 440 is cylindrical, and at least one fixing block 441 is disposed on an outer surface of the optical assembly 440. An inner wall of the plug-in plate 412 defines the fixing groove, and the fixing block 441 is embedded in the fixing groove, so as to fix the optical assembly 440.

As illustrated in FIG. 1, in some embodiments of the present disclosure, the middle housing 420 is provided with a locking groove 421. The locking groove 421 includes a moving section and a limiting section. The moving section extends along the axis direction of the middle housing 420, and the limiting section extends along the circumferential direction of the middle housing 420. A locking block 431 is disposed on the base body 430. During installation, the moving section aligns with the locking block 431. The locking block 431 moves into the limiting section through the moving section, the middle housing 420 is rotated relative to the base body 430, thereby limiting the relative movement of the middle housing 420 and the base body 430 in the axial direction. A radial diameter of the near-eye display module 01 is less than or equal to 18 mm, such as 18 mm, 17 mm, 16 mm, 15 mm, 14 mm, 13 mm, 12 mm, 11 mm, 10 mm, 9 mm, 8 mm, 7 mm, or the like. The height of the near-eye display module 01 is less than or equal to 18 mm, such as 18 mm, 17 mm, 16 mm, 15 mm, 14 mm, 13 mm, 12 mm, 11 mm, 10 mm, 9 mm, 8 mm, 7 mm, or the like.

In some embodiments, the housing 400 further includes the middle housing 420 and the base body 430. The middle housing 420 is provided with the locking groove 421, and the base body 430 is provided with the locking block 431. The battery 442 is located between the middle housing 420 and the base body 430, and the locking block 431 is configured to be detachably connected to the locking groove 421. One or more of various mechanisms may be disposed, so as to fix and release the components. In some embodiments, it may include the mechanism, such as a lock, a latch, a buckle, a slider, a channel, a screw, a clasp, a thread, a magnet, a pin, an interference (e.g. friction) fit, a roller, a locking pin, a fusion material, a fabric, a knitwear, a woven fabric, a hook-and-loop fastener, and/or a combination thereof.

In some embodiments, the near-eye display module 01 further includes a second magnetic element 522. The second magnetic element 522 is located between the battery 442 and the base body 430. The second magnetic element 522 may be adhered or clamped onto the base body 430. The second magnetic element 522 is configured to attract an external magnetic element. The second magnetic element 522 may be flat-shaped. The second magnetic element 522 may be a magnet that may attract the external magnetic element. In some embodiments, the second magnetic element 522 may also be a metal iron sheet that may be attracted by the magnet.

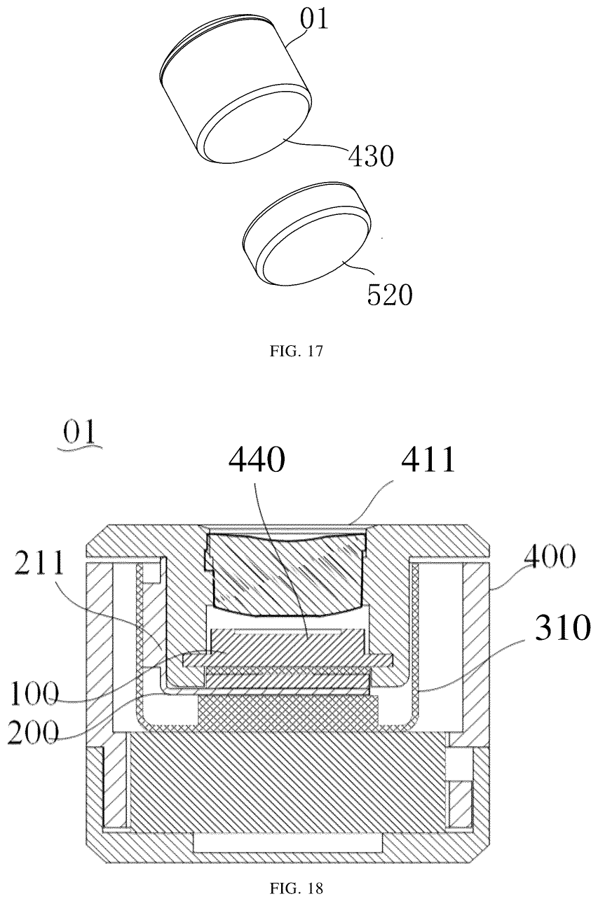

As illustrated in FIG. 16, the present disclosure further provides a near-eye display device 02. The near-eye display device 02 may be AR glasses, VR glasses, or myopia glasses, or the like. The frame 500, the lens 510 disposed in the frame 500, and the near-eye display module 01 as described above. In some embodiments, the near-eye display module 01 is connected to the frame 500, and the near-eye display module 01 may be located on a side surface of the frame 500 close to or facing the human eye. The transparent portion 411 of the near-eye display module 01 faces the lens 510. Alternatively, the transparent portion 411 of the near-eye display module 01 may directly face the human eye. The near-eye display module 01 may be fixed on the frame 500 and/or the lens 510 through a clamping assembly. Alternatively, as illustrated in FIG. 17, the near-eye display module 01 may be fixed on the frame 500 and/or the lens 510 through a first magnetic element 520. The base body 430 of the near-eye display module 01 is configured to be attracted by the first magnetic element 520. In some embodiments, a magnetic member that mutually attracts with the first magnetic assembly 520 may be disposed on the side surface of the near-eye display module 01 opposite to or away from the optical module. In some embodiments, the first magnetic element 520 and the magnetic member may be mutually attracted magnets. That is, two magnets may be mutually attracted, so as to fix the near-eye display module 01 on the lens 510, such as the lens of glasses or the lens of a helmet, or the like. The frame 500 or the lens 510 may be included the myopia glasses, farsightedness glasses, sunglasses, the AR glasses, the VR glasses, the smart glasses, goggles, safety helmets, cycling helmets, smart helmets, or the like. By setting the control plate assembly 300 and the storage assembly 200 as the structures connected by multiple plates, the control plate assembly 300 and the storage assembly 200 may be folded to form the three-dimensional space. The installation space may be fully utilized, thereby avoiding the sizes of the control plate assembly 300 and the storage assembly 200 from being too large in the single direction. Thus, the overall structural layout of the near-eye display module 01 is more reasonable, and the structure is more compact. During using the near-eye display device 02, it may reduce the discomfort caused by the large size of the near-eye display module 01 to the human eye. The small-sized design may hide the near-eye display module 01 in appearance without interfering with the normal field of view. The overall size and weight of the near-eye display module 01 are small, which may improve comfort. In addition, the small-sized near-eye display module 01 may be conveniently fixed in any position in a detachable manner for the above-mentioned head mounted devices, thereby achieving compatibility and intelligent expansion of traditional head mounted near-eye devices.

In the near-eye display module provided in the present disclosure, the control plate assembly, the display assembly, and the storage assembly are set as multiple independent structures that are assembled and connected. Each structure may form a corresponding construction and space after folding a corresponding one of the fold sections. The folded structure and space are fully utilized for assembly, so as to effectively reduce the size of the control plate assembly, effectively reduce the size of the display assembly, and effectively reduce the size of the storage assembly in a single direction, thereby avoiding the overall assembly size from being too large caused by excessive sizes of the control plate assembly, the display assembly, and the storage assembly in the single direction. Thus, it ensures that the overall structure assembly layout of the near-eye display module is reasonable and the structure is more compact, which is conducive to reducing costs and improving assembly efficiency. In addition, the small-sized near-eye display module effectively improves the portability and mobility of the product, thereby greatly enhancing the application scenario of the near-eye display module.

Finally, it should be noted that the above embodiments are only used to illustrate the technical solutions of the present disclosure, but not to limit the technical solutions. Although the present disclosure has been described in detail with reference to the foregoing embodiments, those of ordinary skill in the art will understand that the technical solutions described in the foregoing embodiments may still be modified or some of the technical features may be equivalently replaced. However, these modifications or replacements do not allow the essence of the corresponding technical solutions to depart from the spirit and scope of the technical solutions of the embodiments of the present disclosure.

What is claimed is:

1. A near-eye display module, comprising:
a housing, defining an installation space;
a control plate assembly, disposed in the installation space, wherein the control plate assembly comprises a main control plate and an adapter plate, the adapter plate is connected to a side edge of the main control plate;
a display assembly, disposed in the installation space and electrically connected to the control plate assembly; wherein the display assembly comprises a first base, a second base, and a micro-display disposed on the first base, and the first base is connected to the second base; and
a storage assembly, disposed in the installation space and electrically connected to the display assembly; wherein the storage assembly comprises a second plate body, a first plate body, and a storage chip disposed on the first plate body; the second plate body is connected to the first plate body, and the first plate body is configured to be non-parallel to the second plate body after folding a fifth fold section;
wherein the adapter plate is configured to at least partially overlap with the main control plate after folding a first fold section in a first direction, and the second base is configured to at least partially overlap with the first base after folding a fourth fold section in the first direction; the second plate body is configured to be located between the main control plate and the second base, and allow the storage chip to be electrically connected to the micro-display; the first base and the second base are configured to clamp the adapter plate and allow the micro-display to be electrically connected to the main control plate; and the light-emitting surface of the micro-display is opposite to the adapter plate in the first direction.

2. The near-eye display module according to claim 1, wherein the near-eye display module further comprises a first power plate connected to a side edge of the main control plate and a second power plate connected to another side edge of the main control plate, the first power plate is spaced apart from the second power plate, the first power plate and the second power plate are electrically connected to the main control plate, each of the first power plate and the second power plate is configured to be non-parallel to the main control plate after folding a third fold sections, and the first power plate and the second power plate are located on different planes;
the first power plate, the second power plate, and the main control plate form an accommodation space; the display assembly and the storage assembly are located in the accommodation space; and a height of the micro-display is less than that of the accommodation space.

3. The near-eye display module according to claim 2, wherein the near-eye display module further comprises an antenna plate, the antenna plate is connected to yet another side edge of the main control plate and is spaced apart from the first power plate and the second power plate, the antenna plate is configured to be non-parallel to the main control plate after folding a second fold section and located on a different plane from the first power plate and the second power plate, the antenna plate is electrically connected to the main control plate, the height of the micro-display is less than that of the antenna plate, and the antenna plate is provided with an antenna and configured to communicate with an external device.

4. The near-eye display module according to claim 3, wherein the near-eye display module further comprises a battery electrically connected to the main control plate, the first power plate, and the second power plate; and the battery is located on a side of the main control plate opposite to the second plate body, and the battery is approximately parallel to the main control plate.

5. The near-eye display module according to claim 4, wherein the near-eye display module further comprises the first fold section, the second fold section, two third fold sections, the fourth fold section, and the fifth fold section;
the adapter plate is connected to the main control plate through the first fold section, the antenna plate is connected to the main control plate through the second fold section, and the first power plate and the second power plate are respectively connected to the main control plate through a corresponding one of the two third fold sections; and the antenna plate, the first power plate, the adapter plate, and the second power plate are distributed at intervals along a circumferential direction of the main control plate;
the first base is connected to the second base through the fourth fold section, and the second plate body is connected to the first plate body through the fifth fold section; and each of the first fold section, the second fold section, the two third fold sections, the fourth fold section, and the fifth fold section comprises a flexible circuit plate.

6. The near-eye display module according to claim 5, wherein the antenna plate, the first power plate, the adapter plate, and the second power plate are further configured to be approximately coplanar with the main control plate; and/or
the second base is further configured to be approximately coplanar with the first base after unfolding the fourth fold section; and/or
the first plate body is further configured to be approximately coplanar with the second plate body after unfolding a fifth fold section.

7. The near-eye display module according to claim 5, wherein each of the main control plate, the antenna plate, the first power plate, the adapter plate, and the second power plate comprises a first surface and a second surface opposite to the first surface;
the first surface of the adapter plate is provided with a first connection bit, the second surface of the adapter plate is free of any element, and the first surface of the adapter plate is configured to face the first surface of the main control plate after folding the first fold section;
the first surface of the main control plate is provided with a main control unit and a plurality of main control sub-elements, and the second surface of the main control plate is provided with a power connection bit electrically connected to a battery;
the first surface of the first power plate and the first surface of the second power plate are respectively provided with a plurality of power sub-elements, the second surface of the first power plate and the second surface of the second power plate are free of any element, each of the first surface of the first power plate and the first surface of the second power plate is configured to form an angle with the first surface of the main control plate after folding the two third fold sections; and
the antenna is located on the first surface or the second surface of the antenna plate, and the first surface of the antenna plate is configured to form an angle with the first surface of the main control plate after folding the second fold section.

8. The near-eye display module according to claim 7, wherein each of the first base and the second base comprises a first surface and a second surface opposite to the first surface;
the first surface of the first base is provided with the micro-display, and the second surface of the first base is provided with a reinforcement sheet;
the first surface of the second base is provided with a fourth connection bit, and the second surface of the second base is provided with a second connection bit;
the micro-display is electrically connected to the fourth connection bit and the second connection bit through the fourth fold section, the first connection bit is configured to be electrically connected to the second connection bit, and the second surface of the second base is configured to be opposite to the second surface of the first base after folding the fourth fold section.

9. The near-eye display module according to claim 8, wherein each of the second plate body and the first plate body comprises a first surface and a second surface opposite to the first surface, the first surface of the first plate body is configured to form an angle with the first surface of the second plate body after folding the fifth fold section, the first surface of the second plate body is provided with a third connection bit, and a storage chip is located on the first surface or the second surface of the first plate body;
the third connection bit is electrically connected to the storage chip through the fifth fold section, and the third connection bit is configured to be electrically connected to the fourth connection bit.

10. The near-eye display module according to claim 3, wherein each of an area of the adapter plate and an area of the antenna plate is smaller than that of the second power plate, each of an area of the main control plate and an area of the first power plate is greater than that of the second power plate, the first plate body is located between the first power plate and the second power plate, and the first power plate is further configured to be approximately parallel to the second power plate after folding the third fold section 340.

11. The near-eye display module according to claim 3, wherein the near-eye display module further comprises an optical assembly, the optical assembly is disposed in the accommodation space, the optical assembly at least partially overlaps with the first power plate and the second power plate in a second direction, and the second direction is perpendicular to the first direction;
the housing is provided with a light-transmitting part, and the optical assembly is located between the display assembly and the light-transmitting part; and an optical axis of the micro-display, an optical axis of the optical assembly, and a central axis of the light-transmitting part are on the same straight line.

12. The near-eye display module according to claim 11, wherein the housing comprises a cover body, and a fixed step is disposed on a position of the cover body corresponding to the light-transmitting part; a fixed block is disposed on a side surface of the optical assembly, and the fixed block is in direct contact with the fixed step; a gap is between the micro-display and the optical assembly in the first direction, and the light-transmitting part is located in a non-central area of the cover body; and a central axis of the optical assembly is spaced apart from a central axis of the main control plate.

13. The near-eye display module according to claim 4, wherein the housing further comprises a middle housing and a base body, the middle housing is provided with a locking groove, the base body is provided with a locking block, the battery is located between the middle housing and the base body, and the locking block is configured to be detachably connected to the locking groove.

14. The near-eye display module according to claim 13, wherein the near-eye display module further comprises a second magnetic element, the second magnetic element is located between the battery and the base body, and the second magnetic element is configured to attract an external magnetic member;
a radial diameter of the housing is less than or equal to 18 mm, and a height of the housing is less than or equal to 18 mm.

15. A near-eye display device, comprising:
a frame;
a lens, disposed on the frame; and
a near-eye display module, assembled on the frame and/or the lens; wherein the near-eye display module comprises:
a housing, defining an installation space;
a control plate assembly, disposed in the installation space, wherein the control plate assembly comprises a main control plate and an adapter plate, the adapter plate is connected to a side edge of the main control plate;
a display assembly, disposed in the installation space and electrically connected to the control plate assembly; wherein the display assembly comprises a first base, a second base, and a micro-display disposed on the first base, and the first base is connected to the second base; and
a storage assembly, disposed in the installation space and electrically connected to the display assembly; wherein the storage assembly comprises a second plate body, a first plate body, and a storage chip disposed on the first plate body; the second plate body is connected to the first plate body, and the first plate body is configured to be non-parallel to the second plate body after folding a fifth fold section;
wherein the adapter plate is configured to at least partially overlap with the main control plate after folding a first fold section in a first direction, and the second base is configured to at least partially overlap with the first base after folding a fourth fold section in the first direction; the second plate body is configured to be located between the main control plate and the second base, and allow the storage chip to be electrically connected to the micro-display; the first base and the second base are configured to clamp the adapter plate and allow the micro-display to be electrically connected to the main control plate; and the light-emitting surface of the micro-display is opposite to the adapter plate in the first direction.

16. The near-eye display device according to claim 15, wherein the near-eye display module further comprises a first power plate connected to a side edge of the main control plate and a second power plate connected to another side edge of the main control plate, the first power plate is spaced apart from the second power plate, the first power plate and the second power plate are electrically connected to the main control plate, each of the first power plate and the second power plate is configured to be non-parallel to the main control plate after folding a third fold sections, and the first power plate and the second power plate are located on different planes;
the first power plate, the second power plate, and the main control plate form an accommodation space; the display assembly and the storage assembly are located in the accommodation space; and a height of the micro-display is less than that of the accommodation space.

17. The near-eye display device according to claim 16, wherein the near-eye display module further comprises an antenna plate, the antenna plate is connected to yet another side edge of the main control plate and is spaced apart from the first power plate and the second power plate, the antenna plate is configured to be non-parallel to the main control plate after folding a second fold section and located on a different plane from the first power plate and the second power plate, the antenna plate is electrically connected to the main control plate, the height of the micro-display is less than that of the antenna plate, and the antenna plate is provided with an antenna and configured to communicate with an external device.

18. The near-eye display device according to claim 17, wherein the near-eye display module further comprises a battery electrically connected to the main control plate, the first power plate, and the second power plate; and the battery is located on a side of the main control plate opposite to the second plate body, and the battery is approximately parallel to the main control plate.

19. The near-eye display device according to claim 18, wherein the near-eye display module further comprises the first fold section, the second fold section, two third fold sections, the fourth fold section, and the fifth fold section;
the adapter plate is connected to the main control plate through the first fold section, the antenna plate is connected to the main control plate through the second fold section, and the first power plate and the second power plate are respectively connected to the main control plate through a corresponding one of the two third fold sections; and the antenna plate, the first power plate, the adapter plate, and the second power plate are distributed at intervals along a circumferential direction of the main control plate;
the first base is connected to the second base through the fourth fold section, and the second plate body is connected to the first plate body through the fifth fold section; and each of the first fold section, the second fold section, the two third fold sections, the fourth fold section, and the fifth fold section comprises a flexible circuit plate.

20. The near-eye display device according to claim 19, wherein the antenna plate, the first power plate, the adapter plate, and the second power plate are further configured to be approximately coplanar with the main control plate; and/or
the second base is further configured to be approximately coplanar with the first base after unfolding the fourth fold section; and/or
the first plate body is further configured to be approximately coplanar with the second plate body after unfolding a fifth fold section.
